(19) United States
(12) Patent Application Publication
(10) Pub. No.: US 2026/0296931 A1
(43) Pub. Date: Oct. 1, 2026

(54) WATER ENRICHMENT SYSTEM

(71) Applicant: GREEN TECH WATER LTD, Afula (IL)

(72) Inventors: Haim WILDER, Raanana (IL); Abraham Jacob DOMB, Jerusalem (IL)

(73) Assignee: GREEN TECH WATER LTD, Afula (IL)

(21) Appl. No.: 19/474,766

(22) PCT Filed: Jun. 6, 2024
(86) PCT No.: PCT/IL2024/050559

§ 371 Date: Oct. 13, 2025

Related U.S. Application Data
(60) Provisional application No. 63/471,776, filed on Jun. 8, 2023.

(51) Int. Cl. C02F 1/68; A47G 21/18

(52) U.S. Cl. CPC C02F 1/688; A47G 21/183; A47G 2400/04

(57) ABSTRACT

The technology includes means for enriching drinking water with nutrients and methods of use.

### FIELD OF THE INVENTION

The technology generally concerns means for enrichment of drinking water with nutrients, including minerals, vitamins, herbal extracts and other agents for wellbeing.

### BACKGROUND

Drinking water is the simplest way to deliver nutrients to the body. Drinking water contains nutritionally beneficial minerals such as sodium, potassium, calcium, magnesium, zinc, copper and phosphate. Nutrients that are typically available through a balanced diet are not always available due to such variables as poor dietary choices, restricted food availability, and specific health conditions can lead to inadequate nutrients intake. Ensuring consistent and sufficient intake of nutrients remains challenging, especially for individuals with busy lifestyles or limited access to a balanced diet.

To bridge these nutritional gaps, the development of nutritional supplements has been pursued and beverages fortified with micronutrients have gained popularity in promoting human health. Soft drink manufacturers have introduced drinks enriched with vitamins. Examples include Diet Pepsi Max with ginseng and Coca-Cola's Diet Coke Plus, enriched with vitamins and minerals. While such drinks are fortified with micronutrients, they also contain high levels of sugar and calories.

### SUMMARY OF THE INVENTION

Water, as an affordable most consumed beverage globally by volume, presents itself as a potential substrate for nutrition supply. Enriching water with nutrients offers an accessible method for individuals to supplement their daily nutrient intake. To date, several commercial products have entered the market, aiming to provide fortified beverages by simply adding premix additives with drinking water. These additives include effervescent tablets, powdered mixes, and liquid drops aimed to enhance the nutritional content of water. While such products offer convenience and ease of use, their limitations impact their effectiveness. These products lack sustained-release properties; the nutrients are rapidly released upon dissolution, leading to a short window for nutrient absorption and necessitating frequent consumption throughout the day to maintain consistent nutrient supply.

Non-compliance with nutritional supplement regimens is also a limitation, resulting in suboptimal outcomes. Considering that some of the water enrichment products contain high sugar content, artificial flavors, or sweeteners, the suboptimal outcome is further reduced.

To overcome the shortcomings of the water-enrichment technologies, the inventors of the technology disclosed herein have developed an add-on or an auxiliary element, referred to herein as a “pod”, that can be easily incorporated in water dispensing systems or units, providing controlled delivery of nutrients, minerals and other additives of choice. The pod containing an enriched composition of materials, e.g., nutrients, minerals and additives, may be completely replaceable, or may be configured to hold a replaceable capsule containing the functional materials. The pod is shaped and structured to be mounted onto any conduit of a drinking or a water-supply unit or a tap of any water supply unit such that water is flown mainly through the pod, thereby enriching the water stream with the materials. The release rate of these materials into the water stream may depend on a variety of factors, such as the suction applied onto the conduit, e.g., a drinking rod, configured with the pod, or pressure imposed on the pod by water flowing therethrough, or generally on the rate of water flow through the pod. Thus, the release rate may be defined as a water contact-dependent release, whereby only when water is caused to flow through the conduit and the pod, the materials are released into the water stream. The pod of the invention constantly enriches water coming in contact with the content of the pod so that a certain predetermined dose of nutrient may be provided to the user for a period of at least 24 hours, or 7 days or more, when using a system implementing the pod.

The pod restricts the release of nutrients by a rate controlling membrane or a matrix and by restricting the contact of water with the composition of nutrients contained in the pod. If the pod is constantly in contact with water, the maximal dose of nutrients that can be released to the water is dependent on the release profile through the membrane or matrix, as a function of water contact time.

In its broadest scope, the invention concerns a detachable pod configured for reversible installation in a flow path of water flown from a water source (e.g., water reservoir, water basin, water tank, water stream, tap, etc) to a water output port, the pod having walls defining a chamber or a pocket enclosing an enriched composition of materials; and having one or more ports, at least one port being shaped and structured, or generally configured, to receive an end of a water stream, i.e., an egress end of a water conduit, and optionally at least one another port that is shaped and structured to receive an ingress end of a water conduit, or an exist port through which enriched or fortified water is delivered to the user.

The invention further provides a detachable pod configured for reversible installation in a flow path of water flown from a water source (e.g., water reservoir, water basin, water tank, water stream, tap, etc) to a water output port, the pod having walls defining a chamber or a pocket enclosing an enriched composition of materials; and having two or more ports, at least one port being shaped and structured, or generally configured, to receive an end of a water supply conduit and at least one another port being shaped and structured to receive another end of the water supply conduit, such that water flowing from the end to the another end flows through the pod, effectively contacting the enriched composition of materials, thereby enriching the water.

The invention further provides a pod for enriching water with one or more nutrient, mineral and/or additive, the pod enclosing an enriched composition of one or more nutrient, mineral and/or additive and is configured to reversible mount into a water flow path of a drinking apparatus, such that a flow of water through the pod enriches the water with the one or more nutrient, mineral and/or additive.

The “pod” of the invention may be a metallic, a polymeric, a glassy or a ceramic element made of virgin and/or recyclable materials and shaped and sized as an enclosure or reservoir, which may be varied in size and shape to fit into any existing drinking apparatus or any apparatus supplying water to a user. The pod may be shaped as a container or an enclosure that encloses or comprises an enriched composition of nutrients, minerals and/or additives. The enclosure may be formed of a continuous wall or shell or may comprise two or more walls or sections or parts that are detachable and attachable to each other to enable replacement of the pod content. Typically, the pod is formed not to decompose to deteriorate when in contact with water, or overtime. The shape of the pod may be spherical, spheroidal, elliptical, V-shaped, L-shaped, T-shaped or tubular.

The pod may be shaped and sized to fit into any existing water flow line of a drinking apparatus or water supply unit to allow water flow therethrough. The pod may be provided with a plurality of ports, each configured to receive an end of a water flow line. At least one of the ports is configured to receive an egress end of a water conduit flowing water out of the pod (herein an egress port). At least one another port may be configured to receive an ingress end of the water conduit flowing water into the pod (herein an ingress port).

The port may be a jack or a receptacle of a diameter or size or shape that is configured to receive an end of a water conduit which may be in a form of a drinking rod (a drinking strew), a water tubing or a metal tube used to flow water in the water system. The one or more ports may be specifically configured to receive a water conduit of specific diameter or may be a universal port shaped to receive an end of a water conduit of any dimeter and shape. The universal port may be conical to receive conduits of different diameters.

The port may or may not be equipped with a locking element to securely, yet reversibly, attach or associated with a water supply line.

In some configurations, the pod has two or more ports, at least one thereof is an ingress port and another is an egress port, as defined.

In some configurations, water may enter or exit the pod through one or a plurality of pores provided on the pod surface.

The position of the ports (ingress and egress ports) on the pod may be dictated by the drinking apparatus used. Exemplary pod configurations are provided in FIGS. 20-23.

The pod may or may not comprise surface pores which permit diffusion of water into the pod to dissolve some or all of the enriched composition contained therein. The number of the pores and the size of the pores may depend on the release profile, as further described herein.

The pod may be a reusable or a disposable or a biodegradable pod unit. The pod may integrally contain a predetermined amount of an enriched composition of nutrients, minerals and/or additives, or may contain or hold a tablet or a capsule containing the enriched composition. In some embodiments, the pod comprises the enriched composition, and the pod may be dispensable. In some embodiments, the pod is structured to receive a dispensable capsule or tablet being or comprising the enriched composition. In such embodiments, the pod may be reusable.

Any pod of the invention may be provided with a one-way inlet valve (permitting unidirectional flow of water into the pod) and an outlet valve permitting outflow of enriched water from the pod. The pod may comprise a capsule or a tablet of the enriched composition coated with a control-release film. The pod may comprise a film or a layer of an activated carbon. The pod may comprise a purification chamber for further purifying the water flowing through the pod. The purification chamber may comprise a material for removing solids or contaminants, including optionally microbial contaminants from the water.

As stated herein, the pod may be configured to be mounted on a water supply line of any water supply or drinking apparatus. The pod may be mounted on a supply line, at any point along the supply line, as depicted for example in FIG. 30B; or may be mounted at an end of a water supply line, as depicted in FIGS. 1 and 30A. The water supply line may be any pipe, conduit, element or otherwise feature of a water supply apparatus or system through which water is delivered from one region or unit of the apparatus or system to another. The water supply line may be a plastic line (e.g., PVC line), a metallic line (e.g., aluminum or brass), a glass line or a water supply line of any other material.

The invention further provides a drinking apparatus or a water supply unit configured with a pod of the invention, the pod being provided in a water supply line between a water source and a water output port, such that water flowing along the water supply line from the water source to the water output port flows internally to the pod, allowing enrichment of the water exiting the output port with one or more nutrients, minerals and/or additives.

The “drinking apparatus” or “water supply unit” may be any apparatus or unit or system for supplying drinking water to a user. Typically, the drinking apparatus or supply unit are household units or bench units which may be configured for supplying water to a single user or multiple users. The apparatus or unit may be electrically operated, mechanically operated, or electro-mechanically operated. The apparatus or unit may be configured for supplying tap water, distilled water, mineral water, hot or cold water, filtered water, purified water, soda or sparkling water, or any type of water, which enrichment is desired. The apparatus or unit or system may be configured for supplying water to a user or for supplying water into a water storage means such as bottles, containers, basins, vessels, etc, suitable for use by humans or animals. Typically, the apparatus or unit is equipped with a conduit through which water is flown from an internal or an external water reservoir poor in nutrients, minerals or additives to an output port which may be a tap or a faucet or a drinking rod delivering water directly to a vessel of a user's mouth. For example, the apparatus or unit may be a drinking bottle, e.g., a personal drinking water bottle, equipped with a drinking rod (which may be integrally formed with the bottle); a water dispensing unit, or any apparatus, unit or system that is configured to supply water, and which is equipped with a tank or a container; a tubing, a line or a conduit; a pump; a cooling unit and/or a heating unit; valves; etc.

In some embodiments, the drinking apparatus is a water supply system or a water dispenser. The water supply unit or dispenser may be portable or mounted. Examples include water dispensers with refill water containers, wall-mounted water dispensers, table-top water dispensers, direct-piping water dispensers, freestanding vessels of water, drinking fountains, soda fountains and others.

In some embodiments, the drinking apparatus is a personal water bottle equipped with an integrally formed or a replaceable drinking rod (straw) equipped with or configured to associate with a pod of the invention, e.g., wherein the association with the pod is via a port of the pod. Where the apparatus is a water bottle equipped with a drinking rod having a water-immersed or water-engaging end provided with a pod, the pod may or may not have a second port. Water may flow into the pod through a plurality of pores. By applying suction to the external or mouth-end of the rod, water is drawn into the pod through the pores or existing ports, and becomes enriched with the nutrients, minerals and/or additives.

The invention further provides a drinking rod or a drinking straw equipped with a pod of the invention. Generally, the drinking rod or straw has a mouth-end that is intended to be placed in a user's mouth and a water-immersed end intended to be placed in a liquid, e.g., water, to carry the liquid to the user's mouth. The water-immersed end may be equipped with the pod so that suction force carries the liquid through the pod to the user's mouth. The rod or straw may be disposable or replaceable, and thus may be made of plastic or a paper-based material; or the rod or straw may be a reusable utensil made of silicon, metal or a natural material such as bamboo.

The pod may be integrally formed with the drinking rod or may be configured with a port, as disclosed herein, to receive the water-immersed end of the rod.

The invention further provides a water bottle, e.g., a personal bottle, equipped with a drinking rod or a drinking straw having a water-immersed end equipped with a pod of the invention, the pod being detachably connected to the rod end or is integrally formed therewith. The pod may have a port to associate to the rod, the rod may be free of an ingress port. The pod may nevertheless comprise a plurality of pores allowing water to flow into the pod upon suction action by the user.

The enriched composition of nutrients, minerals and/or additives may be provided directly in the pod or may be encapsulated or contained in a tablet or capsule that can be fitted within the pod and which is replaceable. In most general terms, the enriched composition may be provided in a variety of forms and compositions and may be tailored to fit any design of the pod, may contain different ingredients suitable per consumer desire, may be tailored for immediate release or prolonged release, etc. In some embodiments, the enriched composition is provided in a form of a tablet of compressed nutrients, minerals and/or additives. In some embodiments, the enriched composition may be provided in a form of a capsule containing nutrients, minerals and/or additives. The capsule may be a metallic or polymeric capsule or enclosure containing the composition in a compressed or powder form. In some embodiments, the enriched composition is provided as separate powders or granules of different nutrients, minerals or additives that can be mixed by the end-user to meet their desired water content.

In some embodiments, the enriched composition may be provided in a form of a compressed tablet coated with a single layer or a multilayer of a controlled release coating or semipermeable membrane or material, wherein the single layer or the multilayer is designed to release the tablet content at a predesigned rate, as a function of pressure gradient formed in the tablet due to water flowing through the tablet, as a function of osmotic pressure variations, etc.

In some embodiments, the enriched composition may be provided as a tablet with a semipermeable coating formed thereon.

In some embodiments, the enriched composition may be provided as a coated tablet of compressed nutrients, minerals and/or additives with a rate controlling membrane that releases its content over time by diffusion through the coated membrane.

In some embodiments, the rate-controlling membrane is a semipermeable membrane.

The tablet may be configured as an osmotic-controlled release oral delivery system (OROS), in which osmotic pressure variations regulate the delivery of the content of the tablet. In such configurations, the semipermeable coating provided on the tablet surface is perforated with one or more surface holes or orifices that permit water absorption therethrough via osmosis. Osmotic pressure causes the tablet content to be pushed through the perforations.

In some embodiments, the enriched composition is provided in a tablet form, wherein the tablet is a matrix tablet formed of a mixture of the nutrients, minerals and/or additives and inert polymeric materials such as copolymers of methyl methacrylate and methacrylic acid (such as Eudragits polymers) and cellulose or starch derivatives (such as ethyl cellulose, cellulose acetate, cellulose acetate phthalate, hydroxy propyl cellulose, starch acetate, hydroxyethyl starch), microcrystalline cellulose, copolymers of polyvinyl acetate and polyvinyl pyrrolidone (Kollidon® SR), etc. The release of the tablet content may be through the matrix, which retards the dissolution of the nutrients in the matrix.

In some embodiments, the tablet may be provided with a semipermeable coating such as the one used in dialysis tubing. In some embodiments, the enriched composition is provided in a pod formed as a dialysis pod, permitting release that is controlled by the molecular weight cut-off of the tubing.

In some embodiments, the semipermeable coating may be formed of a material selected from cellulose acetate, ethyl cellulose, starch acetate, ethyl starch and copolymers of acrylic acid and methyl, polysulfone, polyethersulfone (PES), etched polycarbonate, acrylates such as methacrylic acid and methyl methacrylate (including Eudragits polymers) and cellulose or materials such as ethyl cellulose, cellulose acetate, cellulose acetate phthalate, starch acetate, polyvinyl acetate derivatives, polylactide, polycaprolactone and other polymers. The coating is formed by depositing the coating material, e.g., a polymer, onto the tablet external surface by pan-coating where the polymer solution (in solvents such as acetone and ethanol) are spayed onto the tablets while being mixed in the pan-coating chamber. Alternatively, polymer latex dispersions in water may be applied for coating the tablet using pan-coating.

Ready for use latex dispersions for coating of pharmaceutical tablets are commercially available, including EUDRAGIT® FS 30 D, a water dispersion of a copolymer of poly(methyl) methacrylate and methacrylic acid at a 10:1 ratio. The dispersion contains 30% solids and 1-2% of a surfactant. Plasticizers such as triethyl citrate and polyethylene glycol (PEG) may be added to the dispersion before coating to have a flexible coating with PEG serving as porogenic agent. The amount of PEG and plasticizer may determine the flexibility and durability of the coating during use and PEG amount may thus be tuned to the desired release profile.

The term “enriched composition” generally refers to a composition of one or more nutrients, minerals and/or additives that is provided in a concentrate form, namely at a concentration that is typically greater than a dose, e.g., daily dose, of the materials to be delivered. The enriched composition is typically not a herbal composition or a ‘mate’ or any collection of leaves, stems and other plant debris used for infusion of active materials therefrom. The enriched composition is also typically of predetermined composition and ingredient concentrations of amounts; thus, excluding any composition of unknown content (e.g., composition and concentrations).

The composition may comprise the nutrient, mineral and/or additive with or without a solid filler or an inert or non-beneficial solid material. In some configurations and depending on the material used, the nutrients, minerals or additives may be solubilized in a liquid carrier and thereafter loaded onto a solid matrix material to provide a solid composition. The liquid carrier may be water or an alcohol or a pro-nano-lipid dispersion formulation (PNL), as known in the art. The solid matrix may be any filler material such as collagen, acrylates such as methacrylic acid and methyl methacrylate (including Eudragits polymers) celluloses such as ethyl cellulose, cellulose acetate, hydroxy propyl cellulose, microcrystalline cellulose (MCC), and others. In some configurations, the nutrients, minerals or additives may be provided in an encapsulated form in nano or micro-carriers such as nanoparticles, nanoscales, microparticles and others.

The enriched composition may comprise any nutrient, mineral or additive that may be needed, desired or suggested for consumption through consumption of drinking water, or any water-based beverage. The enriched composition may contain, consist or comprise any of the material combinations disclosed herein. The composition may contain only nutrients, only minerals, only additives or any combination of two or more different materials. The selection of materials may be predetermined or formulated by the user. The enriched composition may be suitable for use by the general population or prepared to suit certain populations such as women, pregnant women, infants, teenagers, elderly etc. The nutrients may include vitamins (such as vitamin A, B, B1, B6, B9, C, D, D3 and K), amino acids, proteins, carbohydrates and others. The minerals may be selected amongst calcium, magnesium, zinc, iron, iodine, selenium, sodium, manganese, copper, potassium, phosphorus and others. Additives may include herbal extracts, food additives, flavorings, antioxidants, and others. Non-limiting examples are also listed in the tables below. Each material (nutrient, mineral or additive) constitutes an independent embodiment.

In some embodiments, the enriched composition comprises minerals selected from Mg, Ca, Zn, Fe, and Se; vitamins selected from vitamins A, B, C, D and K; additives selected from herbs such as ginger and curcumin; amino acids such as valine, leucine, isoleucine, threonine, methionine, phenylalanine, histidine, tryptophan and lysine, and others.

The content of nutrients to be released in drinking water can vary based on the customer needs. For example, a tablet for delivering vitamins over a period of 7 days may contain:

Commercial

| | | | Daily Dose |
|---|---|---|---|
| | | Dose in | in Commercial |
| Compound | Daily dose* | tablet | Tablet* |
| Vitamin A | 0.9 mg | 6.3 mg | 1 mg |
| Vitamin B6 | 1.7 | 12 mg | 6 mg |
| Vitamin B1 | 1.5 mg | 10.5 mg | 1.5 mg |
| Vitamin B9 | 0.4 mg | 2.8 mg | 0.5 mg |
| Vitamin C | 90 mg | 630 mg | 120 mg |
| Vitamin D3* | 0.025-0.1 mg | 1 mg | 0.025 mg |
| Vitamin K* | 0.2 mg | 1.5 mg | 0.06 mg |
| Vitamin E* | 15 mg | 105 mg | 27 mg |

*Vitamins E, K, and D3 are dissolved into 200 mg pro-nano-lipid dispersion formulation (PNL), composed of surfactants (Tween, Span) cocoa butter and ethyl lactate. This solution is absorbed into 300 mg MCC to form a powder that can be mixed with the water-soluble vitamins. The formulated insoluble vitamins in PNL forms lipid nanoparticles upon contact with stomach fluids and being absorbed with high bioavailability.
**Recommended daily dose was taken from mayoclinic.org.
***Commercial tablet for reference is Centrum Multivitamins.

Similarly, a tablet containing minerals may be composed of:

| | | | | Daily |
|---|---|---|---|---|
| | | | Dose in | Dose in |
| | | Daily | 7-day | commercial |
| Material | Available form | dose* | tablet | tablet** |
| Magnesium | Mg sulphate | 300 mg | 700 mg | 42 mg |
| Calcium | Ca chloride | 500 mg | 700 mg | 210 mg |
| Zinc | Zn chloride | 10 mg | 70 mg | 15 mg |
| Iron | Fe sulphate | 8 mg | 60 mg | 18 mg |
| Iodine | Potassium iodide | 0.15 mg | 1 mg | 0.15 mg |
| Manganese | Manganese | 2 mg | 50 mg | 4 mg |
| | chloride | | | |
| Copper | Cu sulphate | 0.9 mg | 10 mg | 0.5 mg |
| Excipients | Binding material | - | 190 mg | |

*Recommended daily dose was taken from mayoclinic.org.
**Commercial tablet for reference is Centrum Multivitamins.

Additives may also be present in tablets of the invention. An exemplary tablet comprises:

| | Daily | Dose in | Daily Dose in |
|---|---|---|---|
| Material | dose | tablet | commercial tablet* |
| L-Tyrosine | 500 mg | 500 mg | 500 mg |
| EGCG | 200 mg | 400 mg | |
| Alpha-GPC | 300 mg | 400 | 100 |
| epigallocatechin | 200 mg | 800 mg | Antioxidant and |
| gallate | | | anti-inflammation |
| Polyphenols | 100 mg | 700 mg | Antioxidant and |
| | | | anti-inflammation |
| Excipients | — | 300 | Cellulose derivatives |
| | | | and polymers |

*Reference for this composition is Onnit Alpha Brain supplement. Green tea Catechin are one of the famous trending supplements. Different polyphenols can be used in the same tablet.

Nutrients, such as vitamins, and minerals, are vital for maintaining various physiological functions in the human body. While a balanced diet should ideally provide these nutrients, factors like poor dietary choices, restricted food availability, and specific health conditions can lead to inadequate intake. Products and methods of the invention ensure consistent and sufficient intake of the nutrients especially by individuals with busy lifestyles or limited access to balanced diets. Thus, “enrichment of the water”, or any similar expression, encompasses a provision of increasing a concentration of a nutrient, a mineral or an additive in water flowing through the pod and exiting the output port of a water supply unit or a drinking rod of a water bottle. The enrichment is to levels or concentrations that are generally desired or intended, or which correspond to a daily dose, or which are needed to correct a deficiency in at least one nutrient, mineral or additive, or which are prescribed by a medical practitioner.

Additives may include colorants, sweeteners, fruit extracts, tasting agents, plant extracts and more.

The invention therefore also provides a method for enriching water with nutrients, minerals and/or additives, the method comprising passing a stream of water through a pod of the invention implemented in a water supply unit.

The invention further provides a method for minimizing or preventing diseases and medical conditions associated with deficient consumption of nutrients, materials or additives, the method comprising supplying to a subject suffering or having predisposition from suffering from the medical condition with water enriched with nutrients, minerals or additives according to the invention.

A brief summary of such conditions and diseases are listed below:

| Personal condition | Proposed nutrients |
|---|---|
| Attention-Deficit / | micronutrients, such as minerals and vitamins; polyunsaturated fatty |
| Hyperactivity | acids (PUFAs) such as omega-3 fatty acids; minerals such as Zinc and |
| Disorder (ADHD) | Magnesium; |
| | Vitamin B6; Ginseng and Gingko |
| | Several studies have demonstrated reduced blood plasma levels of |
| | various minerals, such as magnesium, iron, and zinc in children with ADHD |
| | at group level, and their supplementation may reduce ADHD symptoms in |
| | individuals with respective deficiencies. These micronutrients are often found |
| | in different supplement products claim to alleviate ADHD owing to their |
| | following roles: |
| | Research suggests that Omega-3 fatty acids especially EPA |
| | (Eicosapentaenoic acid) and DHA (Docosahexaenoic acid) have a positive |
| | impact on ADHD symptoms and they are important for the development, |
| | function and protection of the nerve cells |
| | Zinc is claimed to promote the effect of activating neurotransmitters |
| | and protects the nerves from the effects of oxidative stress. |
| | Magnesium is claimed to require for energy production and nerve |
| | signals |
| | Vitamin B6 was found to reduce the symptoms of ADHD. |
| | Ginseng and Ginkgo are the herbs claim to improve circulation and |
| | cognitive functions and known to help improve attention and memory |
| Common | Vitamins such as Vitamin C, D, B, E, omega-3 fatty acids; minerals such |
| population | as Magnesium, Calcium, Selenium and Zinc; flavonoids and |
| | polyphenols; probiotics; herbs like Ginseng, Turmeric |
| | These nutrients are commonly found in nutraceutical supplements |
| | intended for daily administration to maintain general health and wellbeing. |
| | Vitamin C is known for its immune-boosting and antioxidant properties. |
| | Vitamin D, also referred to as sunshine vitamin, is essential for calcium |
| | absorption and recommended to maintain bone health, and immune system |
| | regulation. |
| | B group vitamins are considered important for energy production, |
| | nervous system function, and cell metabolism. |
| | Omega-3 Fatty Acids are considered important for heart health, brain |
| | function, and inflammation reduction. |
| | Minerals are involved in numerous biochemical processes in the body |
| | and play a role in muscle and nerve function, energy production, and bone |
| | health. Mineral supplements administration support relaxation, stress |
| | reduction, and overall well-being. |
| | Calcium is essential for maintaining strong bones and teeth. It also |
| | plays a role in muscle function, nerve transmission, and blood clotting. |
| | Calcium intake is recommended to support overall skeletal health. |
| | Zinc is an essential mineral that supports immune function, wound |
| | healing, and cell division. Zinc supplements contribute to general health and |
| | well-being. |
| | Antioxidants, such as vitamin E, selenium, and various plant |
| | compounds (e.g., flavonoids and polyphenols), help protect cells from |
| | oxidative stress and reduce the risk of chronic diseases. They support overall |
| | health and well-being. |
| | Probiotics are beneficial bacteria that support a healthy gut |
| | microbiome. They aid in digestion, enhance nutrient absorption, and |
| | contribute to immune function and overall well-being. |
| | Ginseng is administered to reduce inflammation, boost the immune |
| | system, and boost energy. Another spice found often in commercial |
| | nutraceutical is turmeric displays anti-inflammatory and anti-oxidant |
| | properties. |
| Children | Choline, Phosphatidylserine, essential fatty acid ingredients; alpha |
| | linoleic acid (ALA), Docosahexaenoic acid (DHA), Eicosapentaenoic acid |
| | (EPA), Linoleic acid (LA), Arachidonic acid (ARA), Gamma linoleic acid |
| | (GLA) and conjugated linoleic acid (CLA); Iodine; Flavonoids; |
| | Multivitamins; minerals such as Iron, Calcium, Iron, Zinc and |
| | Potassium; herbs such as Ginseng and turmeric |
| | Choline, and Phosphatidylserine, are administered as supplements in |
| | kids for brain development. They are claimed to support healthy brain |
| | function |
| | Essential fatty acids such as DHA, ALA, CLA etc. are claimed to boost |
| | immunity in children. |
| | Iodine deficiency is the main cause of potentially preventable mental |
| | retardation in childhood, as well as causing goiter and hypothyroidism in kids. |
| | Flavonoids are administered to kids, claimed to alleviate the attention deficit |
| | disorder (ADD) and allergy conditions |
| | Multivitamins are recommended to promote the growth in kids. |
| | Iron is recommended to growing kids to prevent anemia and promote |
| | general growth. |
| | Calcium, Iron, Zinc and Potassium are included in the supplements to |
| | help kids grow and develop. |
| | Ginseng and turmeric for kids supplement market is growing. For |
| | example, the Ginseng and turmeric Jellies for toddlers are products claim to |
| | improve kids' health. |
| Elderly | Calcium and Vitamin D; Antioxidants (folate, B6 and B12); omega 3 |
| | fatty acids, DHA and EPA; prebiotics and probiotics; Potassium; Whey |
| | protein; Coenzyme Q10. |
| | Many people in the higher age categories rely on nutraceuticals to |
| | assist with health-related issues, or to help maintain health. For example, |
| | calcium and vitamin D are administered to ameliorate osteoporosis and other |
| | bone related complications in elders. |
| | Antioxidants are claimed to prevent cancer, heart diseases and |
| | neurodegenerative diseases. |
| | Omega 3 fatty acids are used as anti-inflammatory agents. |
| | Prebiotics and probiotics are administered to maintain healthy gut. |
| | Whey protein is recommended to prevent age-related progressive loss |
| | of muscle mass and strength (sarcopenia). |
| | Coenzyme Q10 is recommended as anti-inflammatory and to maintain |
| | healthy endothelial function. |
| Pregnant women | Folate; minerals such as Iron and Zinc; Vitamin D, Vitamin B12. |
| | Folate is essential for preventing birth defects, especially neural tube |
| | defects. |
| | Iron is also important for brain development and growth of the fetus. |
| | Pregnant women need about twice as much iron as non-pregnant women. |
| | Vitamin D is essential for bone health. It is also important for immune |
| | function and for the development of the fetus nervous system. |
| | Vitamin B12 is essential for the development of the baby's nervous |
| | system and red blood cell production. |
| | Zinc supports immune function and helps with cell division and |
| | growth. It is important for both the mother and the baby's development. |
| Brain injury | Coenzyme Q10 (CoQ10); N-acetylcysteine (NAC); Phosphatidylserine; |
| | Creatine; DHA, Resveratrol, Lipoic acid, Melatonin, Choline, Enzogenol |
| | CoQ10 plays an important role in cellular energy production. It also |
| | acts as an antioxidant and may support mitochondrial function in the brain. |
| | Nutraceuticals containing CoQ10 are sometimes used to aid in the recovery |
| | of brain injury. |
| | N-acetylcysteine (NAC): NAC is an amino acid that acts as a precursor |
| | to glutathione, a potent antioxidant in the body. It may help reduce oxidative |
| | stress and inflammation, potentially supporting brain injury recovery. |
| | Nutraceuticals containing NAC are sometimes used for this purpose. |
| | Nutraceuticals containing phosphatidylserine may be recommended to |
| | support brain health and recovery after injury. |
| | Creatine supplementation is also claimed to be beneficial to brain |
| | health (e.g., cognitive processing, brain function, and recovery from trauma). |
| | DHA, Resveratrol, Lipoic acid, Melatonin, Choline, Enzogenol are |
| | claimed to support recovery in traumatic brain injury. |
| Depression | omega-3 PUFAs; vitamin D; S-Adenosylmethionine (SAMe); Folic acid; |
| | vitamins B12 and B6; Methylfolate and folinic acid; Tryptophan; |
| | minerals such as Zinc; vitamins such as vitamin C, vitamin D; inositol; |
| | creatine |
| | These nutrients are very often found in nutraceuticals; claim to |
| | alleviate the mood and reduce the risk of developing depression. |

The pod may be associated with a specific barcode or tag that may be embedded in the pod, the tablet, capsule or the packaged pod or enriched composition. The barcode or tag may provide indication or identify the pod based on its content, concentration of ingredients, release profile, and may also include warnings as to specific ingredients which may not be suitable for every user population. The barcode or tag may be read by the water supply unit into which the pod is implemented or by a user's barcode or tag reading app.

The invention also provides a provision of a method for enriching a subject's diet with nutrients, minerals or additives, the method comprising dispensing water from a water output port of a water supply unit equipped with a pod according to the invention, wherein the pod is installed in a water flow path extending from a water reservoir or water tank or water source to the water output port.

The invention further provides a method for enriching a subject's diet with nutrients, minerals or additives, the method comprising mounting or installing a pod according to the invention in a water flow path extending from a water reservoir or water tank or water source to a water output port of a water supply unit, and dispensing water from the water output port of the water supply unit.

The methods comprise administering to the subject said waters. The administration may be via subject's drinking immediately following dispensing of the water or at any time thereafter.

Without wishing to be bound by theory or any mechanistic description, release of the nutrients, minerals and/or additives into the water passing through the pod may be controllable to provide immediate release, sustained released or prolonged release, whereby the nutrients, minerals and/or additives are not releasable unless water flows through the pod containing same. In other words, the release of the materials into the water occurs under osmotic pressure or under a pressure gradient caused by a flow of water through the pod. For achieving a controlled release of the nutrients, minerals or additives, the enriched composition, e.g., in a form of a tablet, may be provided in any one or more of the following configurations:
in a compressed form, whereby the degree of compression defines the rate of release from the tablet;
in a coated form, whereby the type of coating (single layer, multilayer, coating thickness, coating composition, etc) defined the rate of release from the tablet;
wherein the nutrients, minerals or additives are provided in an encapsulated form, or in a granulated form such that the release of each component may be differently controlled to supply different amounts or doses of the different materials;
in a compartmentalized form, wherein the tablet comprises different material or composition regions, each provided with a different coating, capable of differently responding to the presence of water, such that each compartment releases its content after a different residence time (time period in contact with water), at a different rate and a different composition of the nutrients, minerals and/or additives.

Where the invention concerns a personal drinking bottle equipped with a drinking rod or a straw, release of the nutrients, minerals or additives into the water may be based on several dosage modes. For example, a continuous dose is designed such that the amount of enrichment materials released into the water is constant and less dependent on the amount of water in the bottle, as long as the concentration in the water is well below the water solubility of the materials being released. This is based on a continuous and constant passage of enrichment materials through a rate-controlling membrane. The rate of passage of a substance is constant as long as there are concentration differences between the two sides of the membrane. The key to obtaining a stable and repeatable system is the selection of polymer membrane materials so that the passage therethrough does not change over time and the surface area through which the substances pass through is constant.

In another example, a dosing-per-passing of water may be designed, whereby release of a dose of materials depends on the customer sipping of the straw resulting in dosing the consumed water with a predetermined amount of materials. According to one configuration, the tablet is isolated from the aqueous environment and only when sipping, the passing water dissolves substances from the tablet. The duration of the contact of the water with the surface of the tablet determines the amount dissolved in the water that is in contact during sipping. It would be possible to determine the dose by mechanical means using pressures or an electronic signal, but these are less desirable.

In some embodiments, the enriched composition is provided in a form of a compressed tablet of nutrients, minerals and/or additives, wherein the tablet is a matrix tablet or a tablet coated with a rate controlling membrane selected to release the nutrients into water over a period of 10 to 200 hours.

From a technical point of view, several profiles of administration can be envisioned. For example, a tablet coated with a membrane designed to deliver a fixed dose for the duration of use. If for example, the tablet is designed to deliver 10% of the recommended daily dose of certain minerals and vitamins for a period of 7 days, a mixture of the selected nutrients, which accounts to 70% of the recommended daily dose, is compressed into a tablet and coated with a rate-controlling membrane that allows the release of the planned dose per day for 7 days into the water, no matter how much water is loaded in a drinking bottle during the day. This tablet is replaced every 7 days with a fresh tablet and the empty tablet is discarded. In a typical example, a tablet may be prepared by pressing a powder or granules composed of calcium sulfate-700 mg, magnesium chloride-700 mg, zinc chloride-70 mg, vitamin B-10 mg, vitamin C-5 mg. The tablet is wrapped in a polymer film made of cellulose acetate or EVA that is perforated by adding 10% to 50% glycerol or PEG400 (a water-soluble substance) which is extracted from the membrane into the water and creates diffusion channels of the size and number, so that the substances in the tablet are released into the water at a constant rate so that the entire amount is released for 7 days.

The controlled release capsule may be a reusable capsule made of a rate controlling membrane or an envelope having a surface of rate controlling membrane where the capsule or envelop is loaded with the deliverable nutrients as powder, granules or beads where the release is controlled by the water penetrating into the capsule through the rate controlling membrane which gradually dissolves the inner capsule nutrients and controlled release through the rate controlling surface.

The invention further provides a device for determining ability of a pod of the invention to enrich water with nutrients, the device comprising a water line equipped with a pod of the invention, the water line having a first end for drawing water from a water reservoir and a second end for outputting water passing through the pod.

In some embodiments, the device is configured and operable to mimic a human sipping process.

In some embodiments, the device comprises a pump, e.g., a peristaltic pump mounted on the first end of the water line.

The invention further provides:

A pod for enriching water with one or more nutrient, mineral and/or additive, the pod enclosing an enriched composition of one or more nutrient, mineral and/or additive and is configured to reversibly mount into a water flow path of a drinking apparatus, such that a flow of water through the pod enriches the water with the one or more nutrient, mineral and/or additive.

In some configurations of a pod of the invention, the pod being a detachable pod configured for reversible installation in a flow path of water flown from a water source to a water output port, the pod having walls defining a chamber or a pocket enclosing an enriched composition of materials; and having one or more ports; at least one port being shaped and structured to receive an end of a water conduit and optionally at least one another port being shaped and structured to receive another end of the water conduit.

In some configurations of a pod of the invention, the pod having two or more ports, at least one port being shaped and structured to receive an end of an egress end of a water conduit and at least one another port being shaped and structured to receive an ingress end of a water conduit.

In some configurations of a pod of the invention, wherein the water source is a water reservoir, a water bottle, a water basin, a water container, a water tank, a water stream, a water vessel or a tap.

In some configurations of a pod of the invention, the water output port is a port of a water dispensing unit configured for delivering a volume of water.

In some configurations of a pod of the invention, the water dispensing unit is a water supply unit or a water dispenser or a drinking apparatus or a drinking bottle, wherein the port is a tap or a faucet of a water supply unit or a drinking apparatus or a mouth-end of a drinking rod provided in a water bottle or water container.

In some configurations of a pod of the invention, the pod being shaped as an enclosure formed of a continuous wall or comprising two or more detachable walls to enable replacement of the pod content.

In some configurations of a pod of the invention, the pod being shaped as a container or an enclosure enclosing or comprising the enriched composition.

In some configurations of a pod of the invention, the pod being shaped as a container or an enclosure enclosing or comprising a capsule comprising the enriched composition.

In some configurations of a pod of the invention, the pod enclosing or comprising a tablet consisting or comprising the enriched composition.

In some configurations of a pod of the invention, the pod comprising surface pores configured to allow water diffusion therethrough.

In some configurations of a pod of the invention, the pod is for enriching water with one or more nutrient, mineral and/or additive, the pod enclosing a compressed tablet of one or more nutrient, mineral and/or additive, the pod being configured to reversibly mount into a water flow path of a drinking apparatus, such that a flow of water through the pod dissolves an amount of the compressed tablet at a rate selected to enrich the water with the one or more nutrient, mineral and/or additive.

In some configurations of a pod of the invention, the tablet is coated with a semipermeable coating.

In some configurations of a pod of the invention, the pod comprising a coated tablet of compressed nutrients, minerals and/or additives with a rate controlling membrane selected to release the tablet content over time by diffusion of the nutrients, minerals and/or additives through the coating membrane.

In some configurations of a pod of the invention, the pod comprising the enriched composition in a form of a tablet configured as an osmotic-controlled release system.

In some configurations of a pod of the invention, the enriched composition is provided in a form of a matrix tablet formed of a mixture of the nutrients, minerals and/or additives and inert polymeric materials.

In some configurations of a pod of the invention, the inert polymeric material is selected from copolymers of methyl methacrylate and methacrylic acid and cellulose derivatives.

In some configurations of a pod of the invention, the enriched composition is provided in a form of a tablet coated with a semipermeable coating formed of a material selected from cellulose acetate, ethyl cellulose, starch acetate, ethyl starch and copolymers of acrylic acid and methyl acrylate.

In some configurations of a pod of the invention, the enriched composition comprising nutrients selected from vitamins, amino acids, proteins, and carbohydrates.

In some configurations of a pod of the invention, the enriched composition comprising minerals selected amongst calcium, magnesium, zinc, iron, iodine, selenium, sodium, manganese, copper, potassium, and phosphorus.

In some configurations of a pod of the invention, the enriched composition comprising additives selected from herbal extracts, food additives, flavorings, and antioxidants.

A drinking apparatus or a water supply unit configured with a pod according to the invention, the pod being provided in a water supply line between a water source and a water output port, such that water flowing along the water supply line from the water source to the water output port flows internally to the pod, allowing enrichment of the water exiting the output port with one or more nutrients, minerals and/or additives.

In some configurations of an apparatus or system or unit of the invention, the apparatus or unit is an electrically operated, a mechanically operated, or an electro-mechanically operated water dispensing unit.

In some configurations of an apparatus or system of the invention, the apparatus or unit is configured for supplying tap water, distilled water, mineral water, hot or cold water, soda water, purified water or filtered water.

In some configurations of an apparatus or system of the invention, the apparatus or unit is a drinking bottle equipped with a drinking rod.

In some configurations of an apparatus or system of the invention, the drinking rod is integrally formed with the pod.

In some configurations of an apparatus or system of the invention, the drinking rod is provided with the pod having a port configured to receive the drinking rod.

In some configurations of an apparatus or system of the invention, the pod having a plurality of pores.

In some configurations of an apparatus or system of the invention, application of suction to a mouth-end of the drinking rod causes water to be drawn into the pod through a plurality of pores, such that water reaching the user's mouth are enriched with the nutrients, minerals and/or additives contained in the pod.

A drinking rod or drinking straw having a water-immersed end equipped with a pod according to the invention.

In some configurations of a drinking rod of the invention, the pod is integrally formed with the end of the drinking rod.

In some configurations of a drinking rod of the invention, the drinking rod is detachably connected to the pod.

In some configurations of a drinking rod of the invention, the pod comprises a replaceable capsule or tablet comprising or consisting an enriched composition.

A water bottle (e.g., a personal water bottle) equipped with a drinking rod having a water-immersed end equipped with a pod according to the invention, the pod being detachably connected to the rod end or is integrally formed therewith.

In some configurations of a bottle of the invention, the bottle is for enriching water poor or of low nutrient, mineral or additive concentration.

In some configurations of a bottle of the invention, the bottle is for enriching water contained in the bottle, allowing a user to consume water rich with the nutrients, minerals and/or additives contained in the pod.

In some configurations of a bottle of the invention, application of suction to a mouth-end of the drinking rod causes water to be drawn into the pod, optionally through a plurality of pores, such that water reaching the user's mouth are enriched with the nutrients, minerals and/or additives contained in the pod.

In some configurations of a bottle of the invention, the nutrients, minerals or additives contained in the pod do not seep out from the pod into the water in the bottle.

In some configurations of a bottle of the invention, the nutrients, minerals or additives contained in the pod seep out from the pod into the water in the bottle.

In some configurations of a bottle of the invention, the pod comprises a replaceable tablet or a capsule containing a compressed enriched composition of nutrients, minerals and/or additives.

In some configurations of a bottle of the invention, the tablet is provided with a semipermeable coating.

In some configurations of a bottle of the invention, the coating is a single layer or a multilayer of a controlled release coating or semipermeable membrane, wherein the single layer or the multilayer is designed to release the tablet content at a predesigned rate.

A method for enriching water with nutrients, minerals and/or additives, the method comprising passing a stream of water through a pod according to the invention, implemented in a water supply unit.

In some configurations of a method of the invention, the water supply unit is a drinking water bottle mounted with a drinking rod equipped with the pod.

In some configurations of a method of the invention, the method is for minimizing or preventing diseases and medical conditions associated with deficient consumption of nutrients or materials, the method comprising supplying to a subject suffering or having predisposition from suffering from the medical condition with the water enriched with nutrients, minerals or additives.

In some configurations of a method of the invention, the method is for enriching a subject's diet with nutrients, minerals or additives, the method comprising dispensing water from a water output port of a water supply unit equipped with the pod, wherein the pod is installed in a water flow path extending from a water reservoir or water tank or water source to the water output port.

In some configurations of a method of the invention, the method is for enriching a subject's diet with nutrients, minerals or additives, the method comprising mounting or installing the pod in a water flow path extending from a water reservoir or water tank or water source to a water output port of a water supply unit, and dispensing water from the water output port of the water supply unit.

In some configurations of a pod of the invention, the pod is formed of a semipermeable envelope loaded with nutrients, wherein the pod is configured for nutrient controlled release.

In some configurations of a pod of the invention, the envelope is a coated tablet of the nutrients with a rate controlling membrane constantly releasing the nutrient content over a period of at least 24 hours.

In some configurations of a pod of the invention, the pod being in a form of an enclosed chamber having semipermeable walls, allowing controlled release of the nutrients upon contact with water.

In some configurations of a pod of the invention, the pod is formed of a biodegradable material.

In some configurations of a pod of the invention, the pod is formed of a reusable material.

In some configurations of a pod of the invention, the pod is implemented in a portable water system.

A device for determining ability of a pod according to the invention to enrich water with nutrients, the device comprising a water line equipped with the pod, the water line having a first end for drawing water from a water reservoir and a second end for outputting water passing through the pod.

### BRIEF DESCRIPTION OF THE FIGURES

In order to understand the invention and to see how it may be carried out in practice, embodiments will now be described, by way of non-limiting example only, with reference to the accompanying drawings, in which:

FIGS. 1A-C are schematic representations of a plastic pod according to some embodiments of the invention, when associated to an end of a straw without the nutrient tablet (A), and with a coated nutrient tablet (B), and a straw when positioned in a personal drinking bottle (C).

FIG. 2 shows the cumulative release of crystal violet in % from dialysis tubing of 12000-14000 Da molecular weight cut off (MWCO)

FIG. 3 shows the cumulative release of Vitamin C in % (determined by UV absorption) from dialysis tubing of 12000-14000 Da molecular weight cut off (MWCO).

FIG. 4 shows the cumulative release of Vitamin B12 in % from dialysis tubing of 12000-14000 Da molecular weight cut off (MWCO).

FIG. 5 shows the cumulative release of Zinc in % from dialysis tubing of 12000-14000 Da molecular weight cut off (MWCO).

FIG. 6 shows the cumulative release of Crystal violet in % from dialysis tubing of 1000-2000 Da molecular weight cut off (MWCO).

FIG. 7 shows the cumulative release of vitamin B12 in % from dialysis tubing of 1000-2000 Da molecular weight cut off (MWCO).

FIG. 8 shows the cumulative release of vitamin C in % from dialysis tubing of 12000-14000 Da molecular weight cut off (MWCO).

FIG. 9 shows a capsule loaded with calcium and magnesium salts and ascorbic acid. The capsule is sealed with a semi-permeable cellulose film and holes in the upper side to enhance the release.

FIGS. 10A-D provide: FIG. 10A Shows the results of vitamin C release from plastic capsule of FIG. 9 over time. FIG. 10B shows the release profile of calcium from plastic capsule with different number of holes, (n=2). FIG. 10C shows the Calcium release from plastic capsule through cellulose membrane with MWCO 12,000-14,000 D, non-flow system, n=2. The release of calcium shows zero-order profile during 90 minutes of release. Amount of calcium released was 46±2% or ~1332 mg. Release rate was 15 mg/min. FIG. 10D shows the Calcium and magnesium release from plastic capsule through cellulose membrane with MWCO 12,000-14,000 D, non-flow system, n=2. The releases of calcium and magnesium show zero order during first 100 minutes of release. After 10 minutes the release shows saturation curve profile. The release profiles of both minerals are similar to each other. Amount of calcium released was 88%±5 (~1525 mg) and amount of magnesium released was 78%±11 (~636.5 mg). Release rate of calcium was ~15 mg/min; release rate of magnesium was ~6.5 mg/min.

FIGS. 11A-D show different cross-section configurations of pods of the invention.

FIGS. 12A-D provide: FIG. 12A shows Calcium release from a capsule through cellulose membrane with MWCO 12,000-14,000 D, flow system, n=2. Calcium release matches zero order at first 12 liters of water filtered through the activated carbon layer during the test. Amount of calcium released was 65.6%±2.7% or ~1895 mg. Release rate of calcium was ~157.9 mg/L. FIG. 12B shows Calcium release from a capsule through cellulose membranes with different MWCO, flow system, n=3. Calcium release matches zero order at first 12 liters filtered through the activated carbon layer during the test. Amount of calcium released through membrane with MWCO 12,000-14,000 D was 65.5%±1.87% or ~1895 mg; release rate was ~158 mg/L. Amount of calcium released through membrane with MWCO 3,500 D was 40%±16% or 1155.5 mg; release rate was ~96.3 mg/L. FIG. 12C and FIG. 12D show Calcium and Magnesium release from a capsule through cellulose membrane with MWCO 3,500 D, flow system, 10 days, n=3. The release profiles of Calcium and Magnesium over a period of ten days are shown. Release profiles of both Calcium and Magnesium shows similar behavior: lag time at first 4 litters (two first days); fast zero order release (~130 mg Ca++/L, ~76.5 mg Mg++/L) during following two days and slower zero order release (~78 mg Ca++/L, ~36.7 mg Mg++/L) for the last five days. Total amount of calcium released was 98.79%±0.76 (~1712 mg) and amount of Magnesium released was 97.87%±1.4 (~898.7 mg).

FIG. 13 show the results of ascorbic acid release from a capsule through cellulose membrane with MWCO 3,500D, flow system, 15 days, n=3. The release profile of ascorbic acid for 15 days shows following behavior: lag time for the first 4 L (two days); zero order release for 10 liters (5 days) and steady state for the last 15 liters (7 days). Total amount of ascorbic acid released was 88.9±4.6%. The release rate at zero order state was 250 mg/L.

FIGS. 14A-C show a tablet before coating (A), After coating (B), and the tablet after 7 days release in water (C).

FIG. 15 shows the release profile of the Minerals from the tablet coated with PLA.

FIG. 16 shows the cumulative release of B1 from the tablets coated with different CA molecular weight at different concentration and with different PEG ratio, the release on the left is for the 10% Cellulose acetate 50 KDa in acetone solution with three different PEG 200 ratios.

FIG. 17 shows the cumulative release of vitamin B1 from tablet coated using cellulose acetate with different ratios of calcium carbonate and PEG 200.

FIG. 18 shows the accumulative release of the (i) vitamin B1 from tablet coated with different glycerol ratio to cellulose acetate, and (ii) Calcium and Magnesium release from the tablet coated with cellulose acetate: glycerol 1:1 at 5% w/w polymer concentration.

FIG. 19 shows the tablet after drying the coating and before starting the release left picture, and after 3 days of release in the middle picture, and at the after 7 days at the last day if the release at the right picture.

FIG. 20 is a perspective view of a water enrichment pod having an L-shape according to some embodiments of the invention.

FIG. 21 is an exploded perspective view of the water enrichment pod according to some embodiments of the invention.

FIG. 22 is a cross sectional perspective view of the water enrichment according to some embodiments of the invention.

FIGS. 23A-D are zoomed-in perspective views illustrating a pod enclosing a water enrichment pod and an operation scheme thereof.

FIG. 24 depicts vitamin B1 accumulative release from tablets coated using 4% w/v cellulose acetate solution and 50% PEG 1500 (ratio to polymer). Set A1 and A2 represent repetition of the release experiment in 50 mL (to reconfirm the release pattern), each set consists of 5 tablets.

FIG. 25 depicts vitamin B1 accumulative release from tablets coated using 3% w/v cellulose acetate solution and 50% PEG 1500 (ratio to polymer). Set A1 and A2 represent repetition of the release experiment in 50 mL (to reconfirm the release pattern), each set consists of 5 tablets.

FIG. 26 depicts magnesium accumulative release from tablets coated using 4% w/v cellulose acetate solution and 50% PEG 1500 (ratio to polymer). Set A1 and A2 represent repetition of the release experiment in 50 mL (to reconfirm the release pattern), each set consists of 5 tablets.

FIG. 27 depicts magnesium accumulative release from tablets coated using 3% w/v cellulose acetate solution and 50% PEG 1500 (ratio to polymer). Set A1 and A2 represent repetition of the release experiment in 50 mL (to reconfirm the release pattern), each set consists of 5 tablets.

FIG. 28 depicts vitamin B1 accumulative release from tablets coated using different concentration of cellulose acetate acetone solution and 50% w/w PEG 1500 (ratio to polymer). The tablets weight gain following the coating experiment is presented in the figure legends. The release rate from coated tablets is dependent on the coating deposition onto the tablet which determines the coating thickness. This data confirms that a 2% coating onto tablet is stable over the release period.

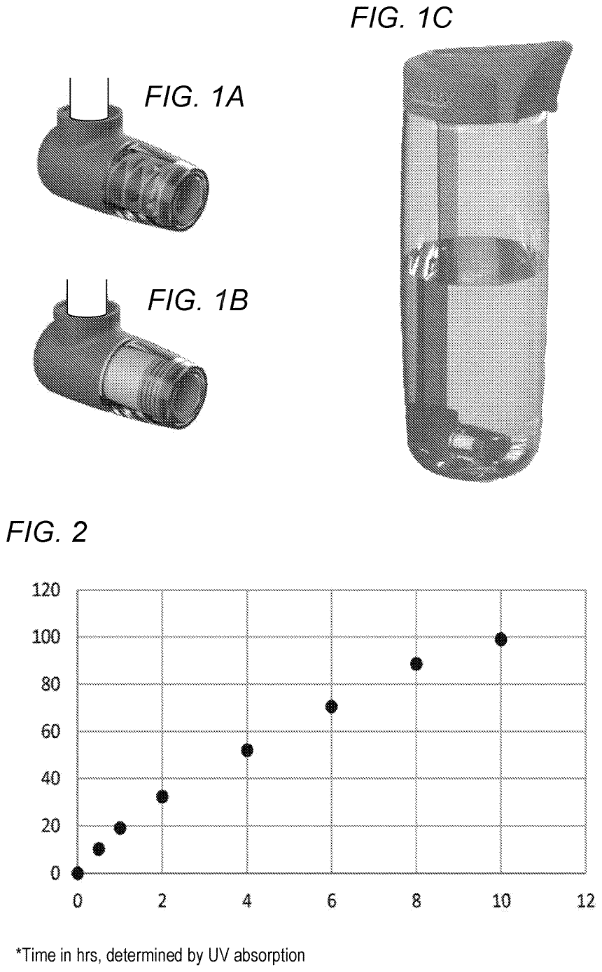

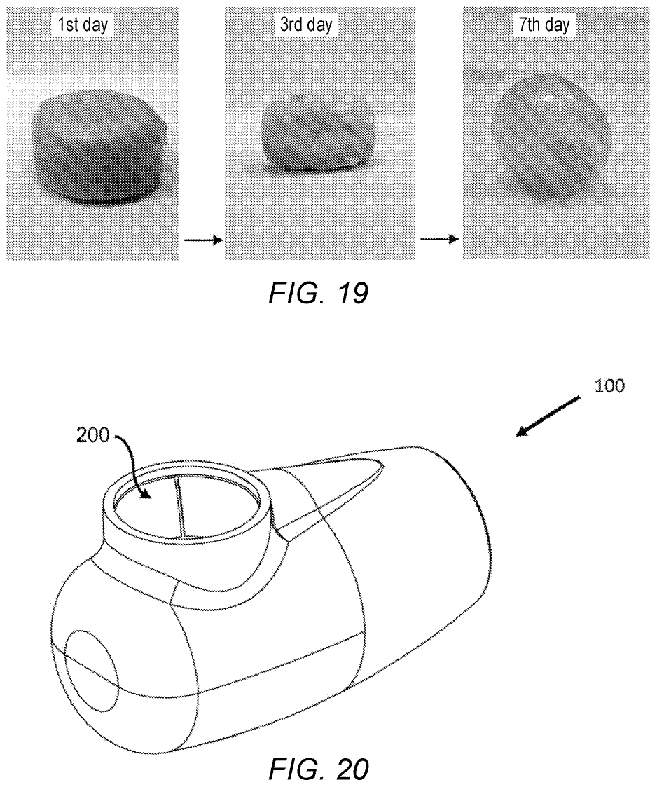

FIG. 19 depicts vitamin B1 cumulative release using the release machine. The release from tablets is constant per the sipping of water from the water chamber. Each data point is a result of a single sipping using the automated device mimicking the human sipping of water from a drinking water bottle.

FIG. 30 is an image of a test set-up mimicking a human sipping process.

FIGS. 31A-B are depictions of a water supply unit equipped with a pod (marked with an arrow) according to the invention, in an output port of the unit (A) or along a water supply line (B).

### DETAILED DESCRIPTION OF THE INVENTION

### Example 1

Development of a Device which Releases Vitamins, Minerals and Healthy Agents in Suitable Amounts in Drinking Water

The enrichment-agents compartment: A tablet of nutrients that is placed inside a drinking water bottle and constantly releases minerals, vitamins and other nutrients to the water at a predetermined release rate to provide a daily dose of nutrients.

Nutrient Delivery: The concept for the delivery product is that each agent will be encapsulated in a rate controlling membrane that guarantees a predetermined release profile for one week of each nutrient. The individually encapsulated agents will be combined into a single unit to be installed into a holder.

The processing of the nutrients involves taking suitable amounts of commercially available nutrients (metal salts or vitamins), granulate them with polyvinyl pyrrolidone (PVP), add inactive ingredients, including microcrystalline cellulose, talk, Mg stearate, etc. and compress them into tablets and dip or spray coat with a permeable polymeric membrane to allow constant release through the coating membrane. After optimizing the release in water and adjusting the amounts of the nutrients to ensure that only amounts that are equal to the RDA amount or a part of it is supplied per day. The water enrichment system is optimized in such a way that the polymer bags containing the nutrients will release a constant amount of the nutrients every hour such that the amount of each nutrient that accumulates per day is predetermined per the RDA.

In a typical experiment, three tablets were prepared:

1. Mg/Ca tablet: 700 mg of Calcium carbonate and 700 mg of Magnesium citrate was granulated with PVP, mixed with MCC and compressed together to generate a 1.5 g tablet.

2. Zn/Se tablet: 70 mg of Zinc Bisglycinate, 1 mg of L-Selenomethionine and 129 mg of Magnesium citrate as filler substance, was compressed together into a tablet of 200 mg.

3. Vitamins tablet: 7 mg of ascorbic acid, 7 mg of cyanocobalamin, 140 mg of thiamine hydrochloride and 140 mg of Riboflavin 5 & #39; —phosphate sodium was compressed together into a tablet of 300 mg.

Coating the tablets: The tablets were coated with rate controlling membrane, as follows: Tablets were individually dip coated by either ethyl cellulose in ethanol (with PEG 400 as a plasticizer) or by ethyl vinyl acetate in acetone/ethanol mixtures or Eudragit RL100 or RS100 in ethanol to produce coated tablets.

Semi-permeable tubing: semi-permeable plastic bags such as cellulose dialysis tubing was used as rate controlling membrane. Such tubing can be made from common polymers such as PE, PET, PU or EVA, prepared by melt sheeting of the polymer mixture with a water soluble porogenic agent such as Mg citrate, CaCO3, ZnCl2, NaCl, glucose, glycerol, propylene glycol, polyethylene glycol, etc. Upon immersing in water, the porogenic agent is dissolved, leaving a porous membrane that allows the release of entrapped solid or solution of the active agent in the bag. The size and tortuosity of the pours across the tubing wall and thickness of the wall, will determine the release rate from the tubing.

Nutrient release was determined and optimized with the help of the Lovibond tintometer, which is a practical colorimeter which is employed to quantify the amount of different nutrients released into the water in the water bottle.

| | | Solubility in | | |
|---|---|---|---|---|
| Nutrient | Commercially available form | water at 25° C. | RDA* | Selected dose |
| Calcium | Calcium Carbonate | 0.015 mg/ml | 800-1200 mg | 100 mg/day |
| Magnesium | Magnesium citrate | 200 mg/ml | 310-420 mg | 100 mg/day |
| Zinc | Zinc Bisglycinate | 194 mg/ml | 8-11 mg | 10 mg/day |
| Selenium | L-Selenomethionine | 50 mg/ml | 55 mcg | 55 mcg/day |
| Vitamin B1 | Thiamine hydrochloride | 100 mg/ml | 1.1-1.2 mg | 20 mg/day |
| Vitamin B2 | Riboflavin 5′-phosphate | 0.13 mg/ml | 1.1-1.3 mg | 20 mg/day |
| | sodium | | | |
| Vitamin B12 | Cyanocobalamin | 12.5 mg/ml | 2.4 mcg | 1 mg/day |
| Vitamin C | Ascorbic acid | 330 mg/ml | 75-90 mcg | 1 mg/day |

*RDA- Recommended Dietary Allowance

### Example 2

Development of a Water Enrichment System with Controlled Release of Several Vitamins and Minerals at Controlled and Steady Rates

Procedure: Controlled steady release of water-soluble vitamins and minerals can be accomplished by two ways.

1. A mixture of the water-soluble vitamins and minerals (quantities of the individual vitamins and mineral shall be based on the daily dietary amounts) (along with a dye that has similar solubility) (5 gm) can be taken in dialysis tubing of suitable pore size (MWCO—as low as possible) and the tubing can be placed in a suitable water bottle, allowing for nutrient release in a controlled and steady manner for 7 days.

2. An alternative approach is to make tablets of the nutrient mixture (1-5-2 gm/tablet—containing 700 mg of Ca2+(RDA=800-1200 mg), 700 mg of Mg2+(RDA=310-420 mg), 70 mg of Zn2+(RDA=8-11 mg), 7 mg of vitamin B12 (RDA=2.4 mcg), 7 mg of vitamin C (RDA=75-90 mcg) and 0.1% crystal violet (for detection) and then coating the tablet with 10% (W/V) polyurethane (Pellethane B) or 10% polyurethane (W/V) (containing 10% Polyethylene glycol 400 (10% of the weight of polyurethane) by dip coating it 3 times and ensuring a uniform and complete coating. And then these coated tablets will allow for the controlled release of various nutrients into the water in the water bottle at steady rates) (Note: the dip coating add) about 60-80 mg to the weight of the tablet)

3. The dialysis tubing and/or the tablets shall be placed in a specialized compartment and fitted into the water bottle and this compartment can be swapped out or a new water bottle can be purchased after 7 days.

4. The release of calcium and magnesium can be quantified indirectly by adding crystal violet (a water-soluble dye with a solubility of about 50 mg/ml which is in the same range of the calcium and magnesium salts being used in the tablet and the mixture being added in the dialysis tubing) and measuring the absorbance of the release medium using a UV-Visible spectrophotometer (Crystal violet shows a peak absorbance at 592 nm).

5. For the quantification of Zinc ions, a Lovibond tintometer shall be used to measure the amounts of zinc in the release medium i.e., the water in the water bottle or container.

6. Vitamin B12 shows a characteristic absorbance peak at 215-216 nm, and it can be quantified using a UV-visible spectrophotometer like in point 4.

7. Vitamin C shows a characteristic absorbance peak at 280 nm, and it can be quantified using a UV-visible spectrophotometer like in point 4.

8. Initially, we are trying to show the proof of concept and for this nutrient mixture consists of three water-soluble mineral salts (calcium, magnesium, and zinc) and two water-soluble vitamins (B12 and C) and suitable amounts of this mixture will be loaded into the dialysis tube or made into tablets and the release of several nutrients over the period of 7-8 days shall be analyzed.

### Release Studies

### 1. Dialysis Tubing

1.1. 5 gm of a mixture containing Ca2+, Mg2+, Zn2+, Vit B12 and Vit C in the ratio 1750:1750:175:17.5:17.5 was taken along with 5 mg of crystal violet in a suitable length of dialysis tubing (5 cm) and it was clipped and tied at both ends and a small amount of water was used to dissolve the nutrient-crystal violet mixture in the tubing so that it permits diffusion of crystal violet across the dialysis tubing. Dialysis tubing of 12000-14000 Da molecular weight cut off (MWCO) (i.e., dialysis tubing with a large pore size) was employed for this preliminary experiment which serves as a proof of concept.
1.2. The dialysis tubing containing the mineral-crystal violet mixture was placed in a container containing 500 ml of deionized water and the release of crystal violet, vitamin B12, vitamin C and zinc ions were checked using UV-Visible spectroscopy (for crystal violet and the vitamins) and colorimetry (for zinc) respectively.
1.3. The release was checked at 30 mins, 60 mins, 120 mins, 240 mins, 360 mins, 480 mins and 24 hrs.

### 2. Tablets

2.1. 2 gm of a mixture containing Ca2+, Mg2+, Zn2+, Vit B12 and Vit C in the ratio 700:700:70:7:7 was taken along with 2 mg of crystal violet was taken and tableted using PVP binding at 3 tons thereby generating tablets of size 12-14 mm.
2.2. The individual tablets were dip coated with a 10% (W/V) solution of polyurethane (Pellethane B) in a uniform and homogenous manner and the coated tablets were allowed to dry overnight.
2.3. Each tablet was taken into a 50 ml tube containing deionized water and the release of crystal violet, vitamin B12, vitamin C and zinc ions were checked using UV-Visible spectroscopy (for crystal violet and the vitamins) and colorimetry (for zinc) respectively.
2.4. The release was checked at 30 mins, 60 mins, 120 mins, 240 mins, 360 mins, 480 mins and 24 hrs.

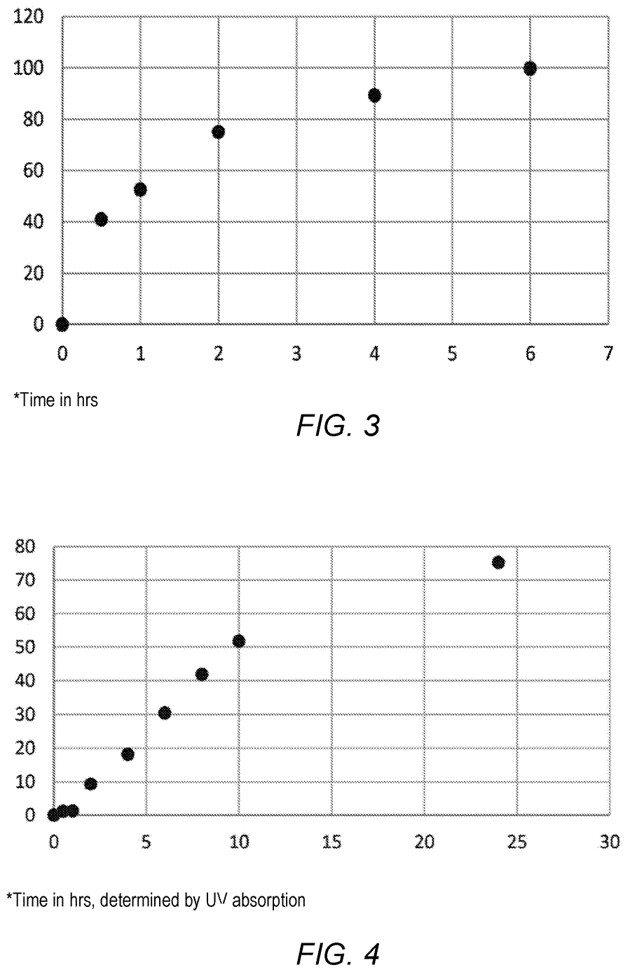

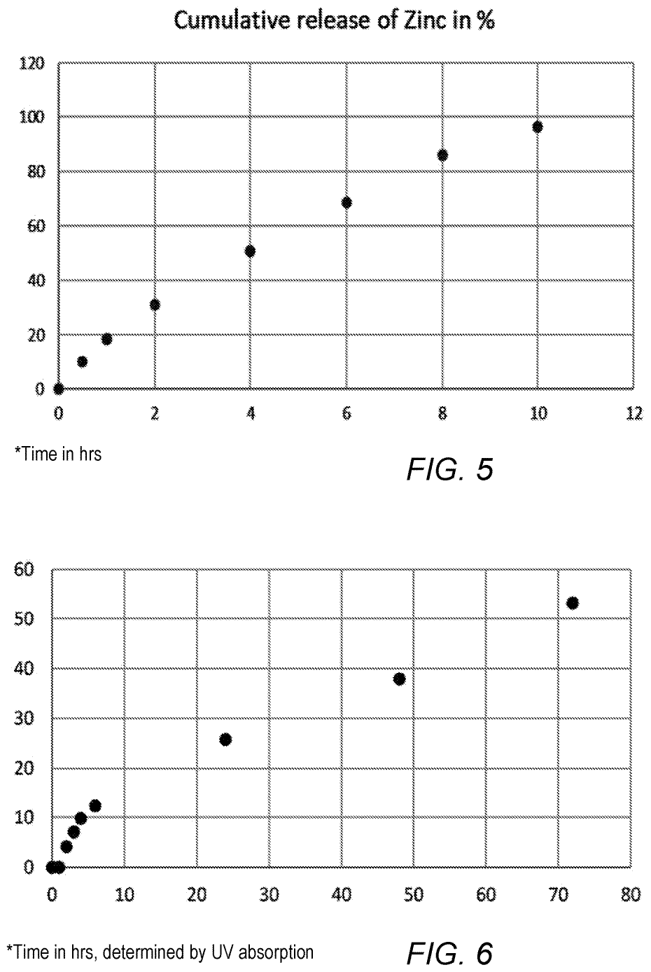

A constant zero order release per day of nutrients and markers were obtained as shown in FIG. 2, FIG. 3, FIG. 4 and FIG. 5.

Summary of the results of the dialysis tubing experiment: As can be seen clearly from the results of the experiment, the crystal violet (which indicates Calcium and magnesium release) was completely released (almost 100%) in 8 hrs. As for vitamin C, it was fully released by the 6-hr mark. Vitamin B12 release was about 75% by the 24 hr mark.

Therefore, since most of the mixture was released, dialysis tubing of a smaller pore size—1000-2000 Da (MWCO) was used to exhibit extended steady release over a period of 7-8 days.

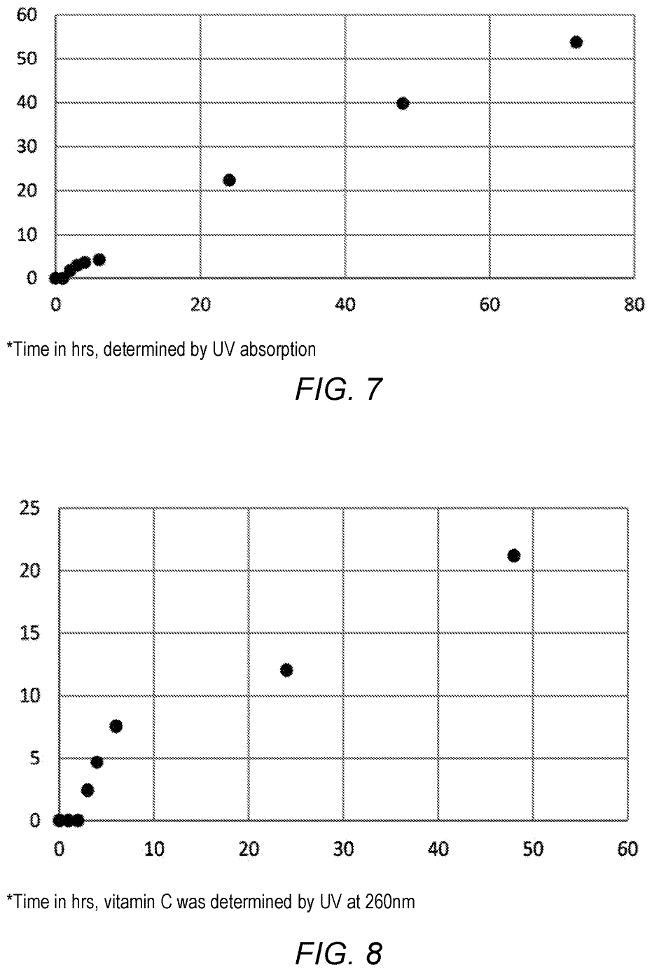

Results are shown in FIG. 6, FIG. 7 and FIG. 8.

### Example 3

### Osmotic Release System

### Minerals and Vitamins Release Studies.

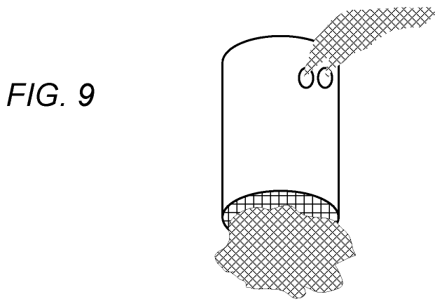

The specially developed plastic capsule was filled with 8 g of dried calcium chloride dehydrate, magnesium chloride, 3:2 mixture of both salts or 6 g of ascorbic acid. The capsule was closed with dialysis cellulose membrane MWCO 12,000-14,000 or 3,500D. As option, the capsule was perforated in the upper side of the capsule (see FIG. 9).

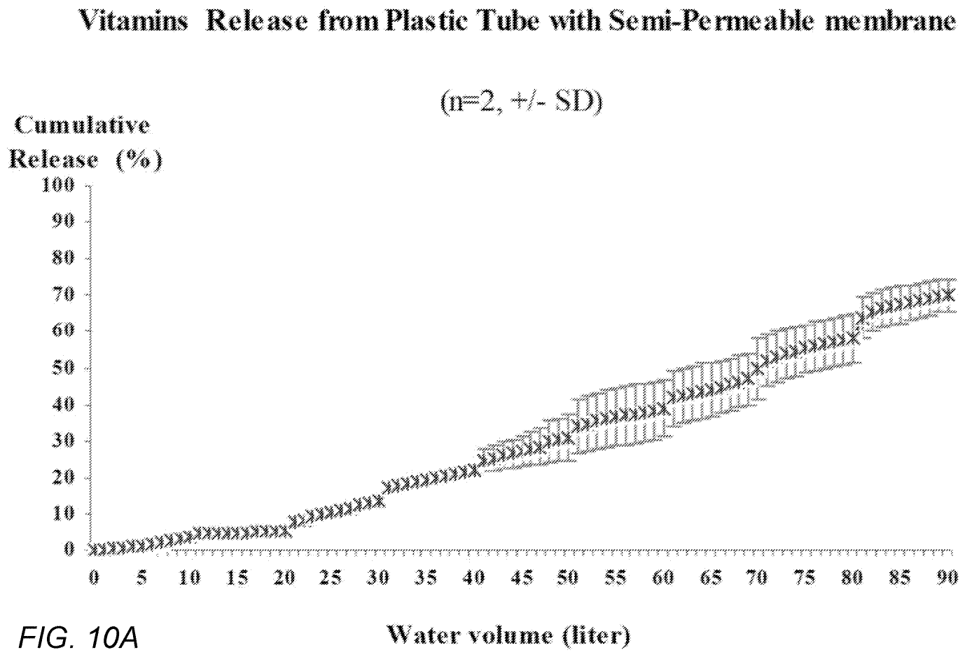

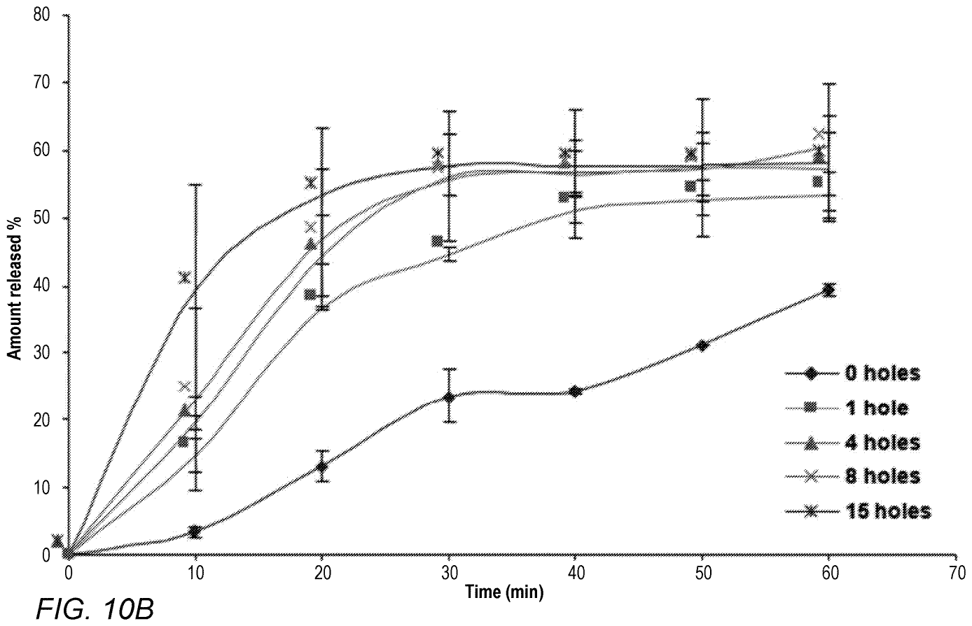

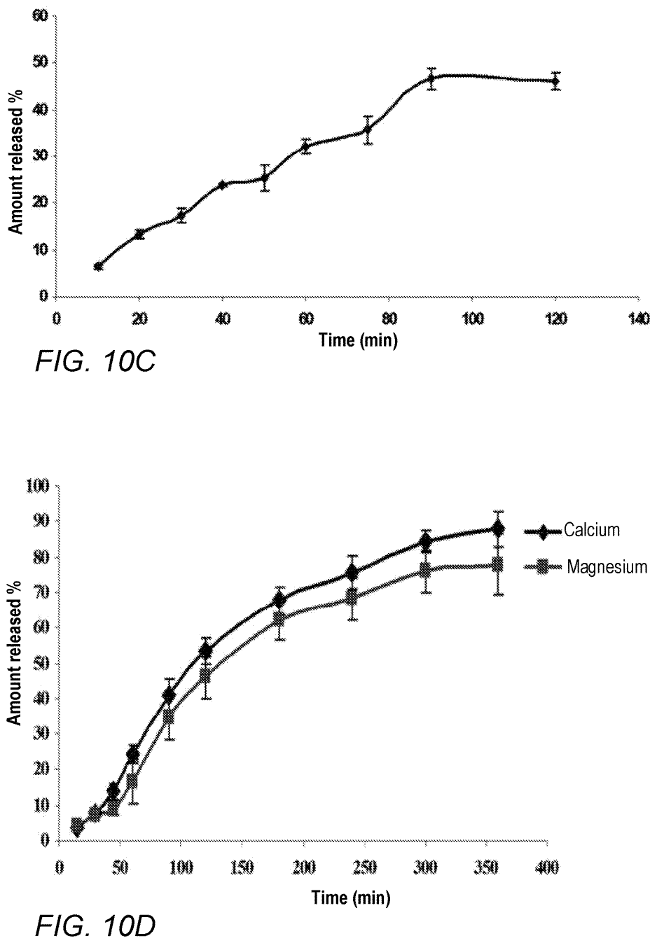

The results of vitamin C release from plastic capsule of FIG. 9 over time is shown in FIG. 10A.

Calcium release from perforated plastic capsules is summarized in FIG. 10B. It can be clearly seen that release from non-perforated capsule approaches zero-order release profile when release from perforated capsules is more similar to saturation curve. The release from more perforated capsule reaches the steady state earlier than release from less perforated capsule.

The release from non-perforated capsule shows zero-order profile when the release from perforated capsules with 1, 4, 8, and 15 holes shows saturation curves. The capsule with 15 holes reaches the maximal release after 20 minutes of release, the capsules with 8 and 4 holes released for 30 minutes and capsules with one hole reaches the steady state after 40 minutes of release.

The results of calcium and magnesium release from non-perforated plastic capsule in non-flow system is summarized in FIGS. 10A and 10B. Release of calcium and magnesium in non-flow system matches zero order during first two hours of release (FIG. 10C), release profile of calcium and magnesium are similar to each other (FIG. 10D).

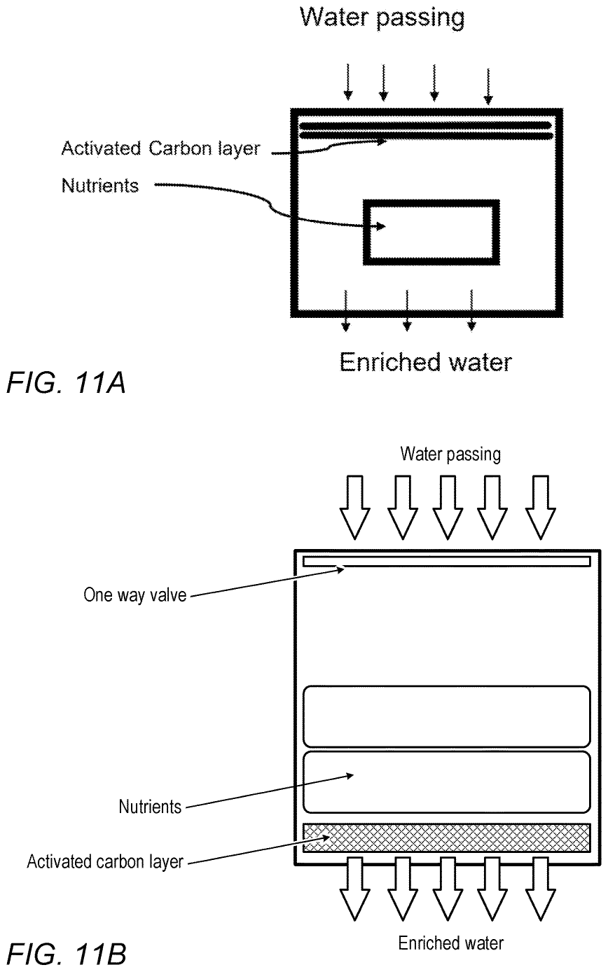

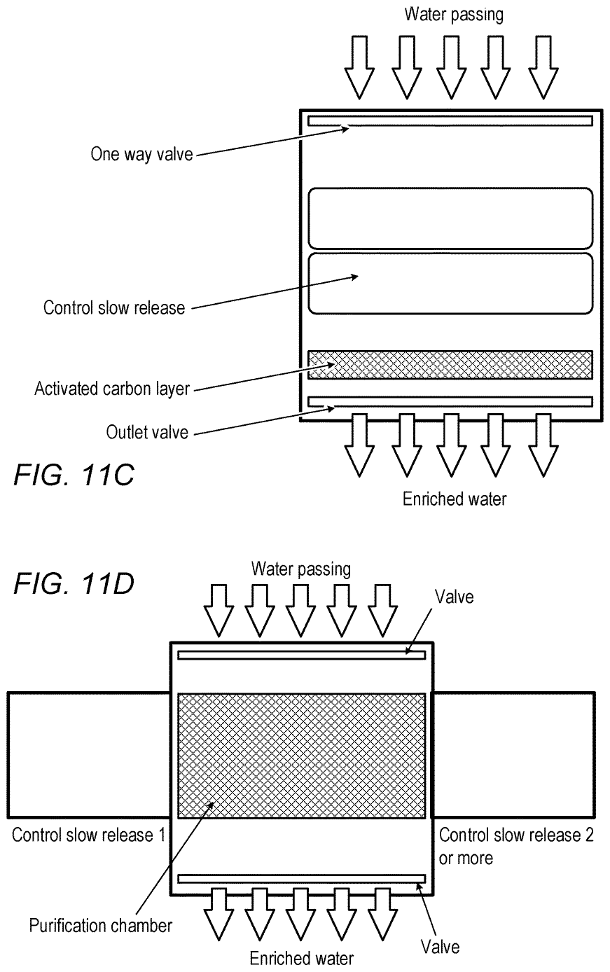

For determination of calcium and magnesium release profile in flow-system the capsule was placed into the specially designed device (FIG. 11) and water flowed through the activated carbon layer.

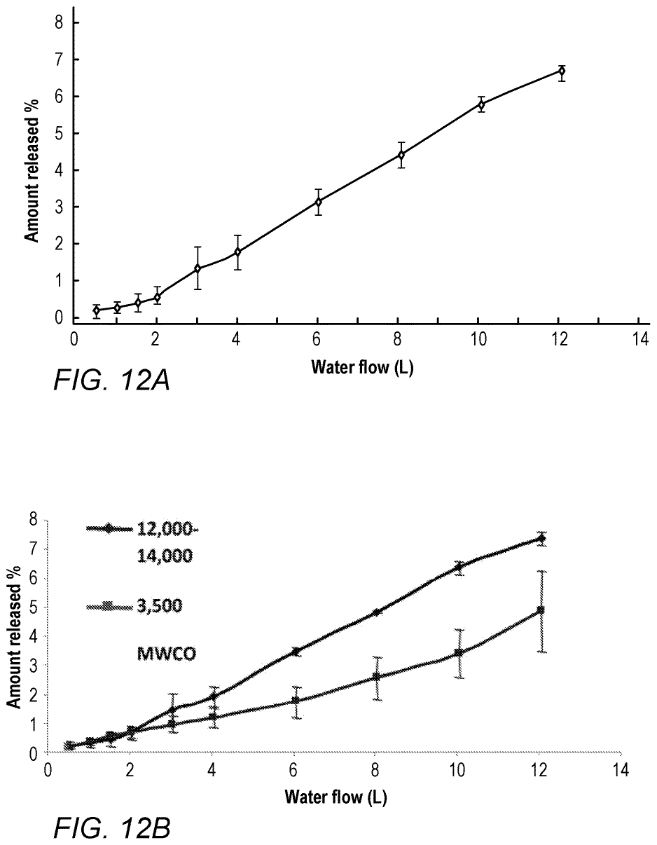

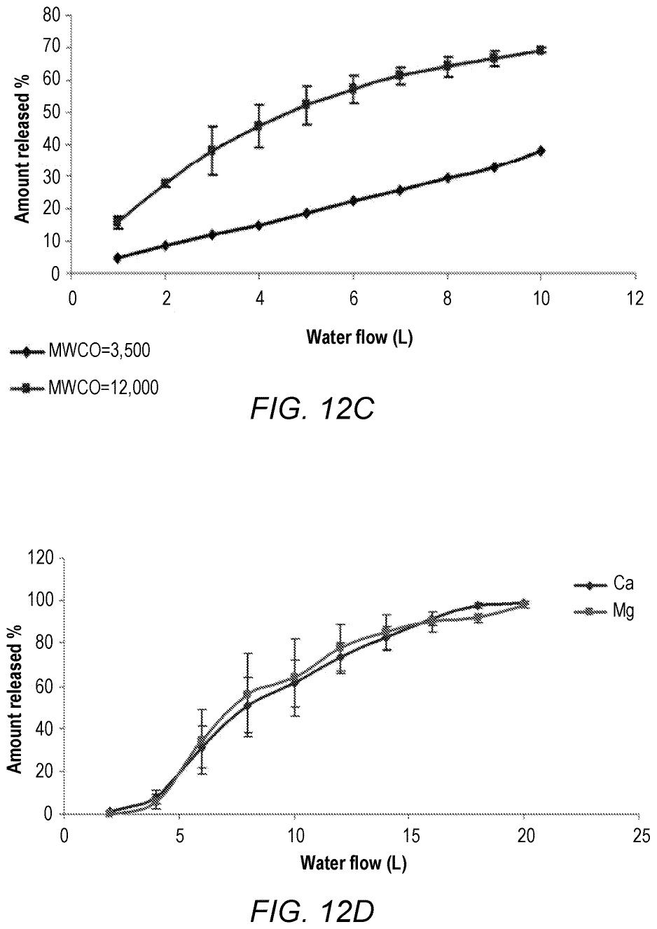

The samples of filtered water were taken from collecting container after filtration of each 2 liters of water. Calcium and magnesium content were determined. The results of calcium and magnesium release from plastic capsule in flow system are summarized in FIGS. 12A-C. The release of calcium in flow system matches zero order (FIG. 12A). The release rate of calcium through cellulose membrane with MWCO 3,500D is slower than release rate through cellulose membrane with MWCO 12,000-14,000D (FIG. 12B). The release of calcium and magnesium through cellulose membrane with MWCO 3,500D for 10 days gives zero order at first 15 liters or at first week of release (FIG. 12C).

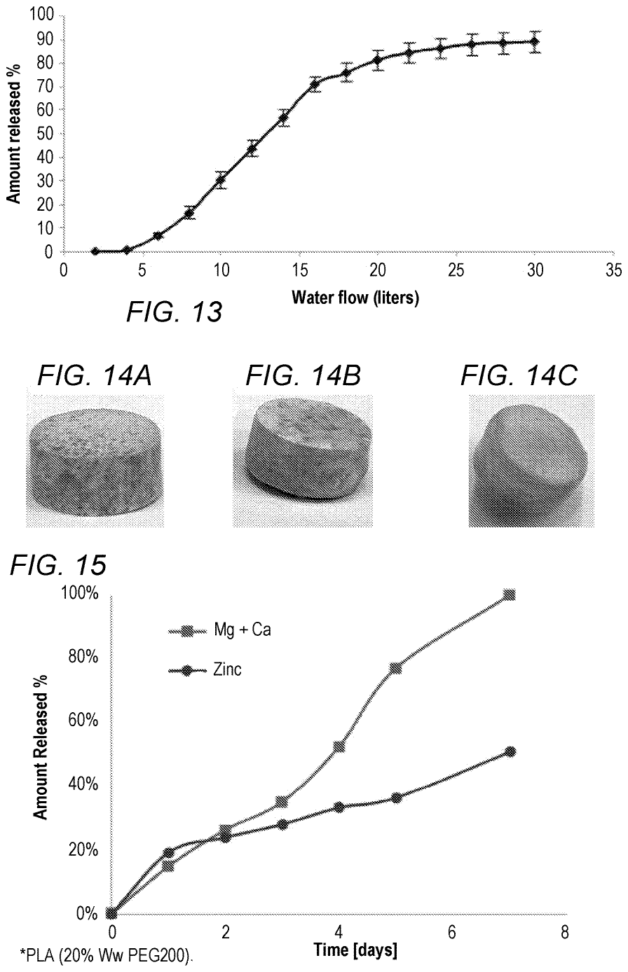

For determination of ascorbic acid release profile in flow-system the capsule was placed into the device (FIG. 11) and water was passed through the activated carbon layer. The samples of filtered water were taken from collecting container after filtration of each 2 liters of water and ascorbic acid content was determined. The results of ascorbic acid release are summarized in FIG. 13. The release profile of ascorbic acid matches zero order (FIG. 13). The release rate of ascorbic acid through cellulose membrane with MWCO 3,500D is slower than release rate through cellulose membrane with MWCO 12,000-14,000D (FIG. 13). The release of ascorbic acid through cellulose membrane with MWCO 3,500D for 15 days gives zero order at first 15 liters or at first week of release. Ascorbic acid was determined by UV at 260 nm.

### Example 4

### Multivitamins and Minerals Tablets for Water Enrichment

The aim of this study is to prepare tablets loaded with vitamins and minerals for a sustained release in water for one week.

Materials: Vitamins: Vitamin B12, Riboflavin (B2), Thiamine HCL (B1), Minerals: Calcium carbonate, Calcium chloride, Magnesium sulfate, Zinc chloride, Coating materials: Polyethene Glycol (PEG 400), Poly lactic acid (PLA), Tablet excipients: Magnesium stearate, Neusilin US2

Method: Tablet preparation: the tablet was prepared by compressing 1.5 g of the formulation powder using tableting punch under pressure of 3 tons for 10 seconds. The material composition in the tablet is mentioned in the table below.

| | | Selected | dose in |
|---|---|---|---|
| | | dose | tablet |
| Material | Commercial form | [mg/day] | [mg] |
| Calcium | Calcium Carbonate | 100 | 100 |
| | Calcium chloride | | 400 |
| Magnesium | Magnesium sulphate | 100 | 500 |
| Zinc | Zinc chloride | 10 | 100 |
| B1 | Thiamine HCl | 20 | 100 |
| B2 | Riboflavin | 20 | 100 |
| Nuesilin US2 | Nuesilin US2 | Excipient | 200 |

*The total weight of the tablet is 1.5 g.

Tablets Coating: The tablets were coated by dipping in the coating solution for several times, the coating layer dried at room temperature for 0.5-1 h between each dipping, and then let to fully dry for 3-4 hours after the last dipping and before starting the release.
Vitamins and Minerals release: the release was done by placing the table in 50 ml of DDW. The release of the vitamins was monitored by measuring the UV at specific wavelength for each vitamin. The release of the minerals monitored using Lovibond device
Calibration Curves for the B vitamins: Vitamin B1 UV calibration curve was established at 235 and 261 nm. Vitamin B2 riboflavin, UV calibration curve was established at 373 and 444 nm.

Results: The prepared tablets were coated by dipping in the CHF solution with the coating polymers, different polymers were used to coat the tablets. the tablets were let dry then placed into aqueous solution to check the stability of the tablet for one week and the minerals and vitamins release, the tablets weight after the coating increased by 8-10% and the coating weight is approximately 120 mg, the tablet before and after the coating is shown in FIGS. 14A and 14B. The highest stability of the coating was observed in the 10% PLA solution in CHF with 20% PEG 200 (w/w to PLA), the tablet didn't break even after one week in aqueous solution, and maintained its shape, as seen in the following FIGS. 14A-C.

The release of the coated tablet was conducted in 50 ml de-ionized water (DDW), and the release medium was replaced and monitored daily. The release of the minerals was performed using Lovibond device using specific tablet for zinc, and specific tablet for magnesium and calcium together (total hardness). The amount released of the Mg+Ca was 100% over 7 days with almost linear profile, as shown in FIG. 14. The zinc released was only 50% of the loaded zinc amount with a linear release profile as seen in FIG. 15.

The release of vitamins B was monitored using UV spectrophotometer, the release lasted for 7 days.

### Example 5

Tablet with Cellulose Acetate Coating for Extended Release of Nutrients

The aim of this work was to optimize cellulose acetate coating with different porosities to allow linear release of vitamins and minerals for 7 days.

Material: Coating polymer: Cellulose acetate 30 kDa and Cellulose acetate 50 kDa from Sigma Aldrich. Tablet content: Calcium chloride from BDH, Magnesium sulphate from Mallinckrodt Chemicals, Thiamine HCL (B1) from Merck Millipore, Magnesium stearate from Thermo Scientific, and Neusilin. Pore forming agents: PEG 200 from Thermo Scientific, Calcium carbonate from Merck, Glycerol from Acros Organic Plasticizer: Diethyl phthalate from Thermo Scientific.

### Method:

### 1.1. Tablets Composition:

| Compound | dose in tablet [mg] |
|---|---|
| Calcium Chloride | 500 |
| Magnesium sulphate | 500 |
| Thiamine HCl (B1) | 170 |
| Mg Stearate - excipient | 30 |
| Neusilin - excipient | 300 |
| Total | 1500 |

### 2. Results:

### 2.1. Cellulose Acetate Different Molecular Weights Containing 5, 10, 20% PEG 200

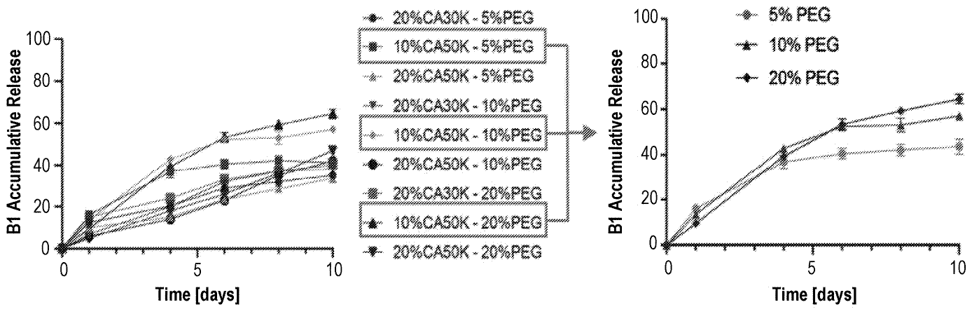

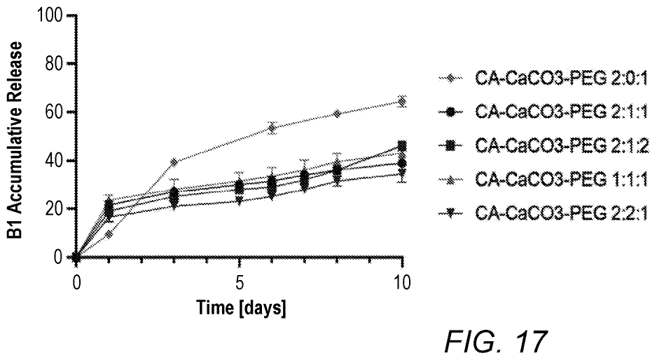

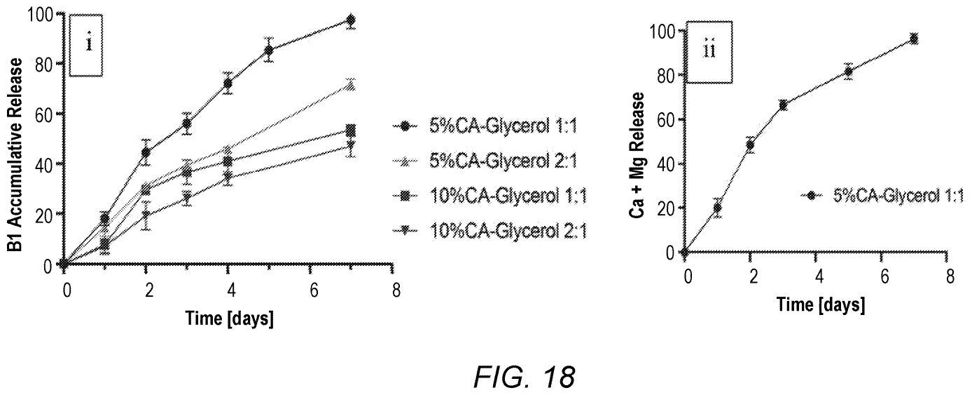

Cellulose acetate of two molecular weights, 30 KDa and 50 KDa, were used. The coating solution was prepared with polymer concentration of 10% and 20% w/v in acetone solutions. The coating was done by dipping the tablet two times and drying the coating for 30 min between each dip. 20% CA of both molecular weights released the vitamins very slowly. Diethyl phthalate (10% w/w to CA) was used as plasticizer in all coating solutions (FIG. 19).
2.2. Cellulose Acetate with Calcium Carbonate and PEG
PEG200 and Calcium carbonate dispersion in cellulose acetate acetone solution were prepared with different ratio of calcium carbonate and PEG to cellulose acetate. The polymer solution concentration is 10% (w/w). it was observed that the use of the calcium carbonate slowed the release of the vitamin B1 compared to using PEG alone (FIG. 17).
Cellulose Acetate: Glycerol with Ratio 1:1 and 1:2
Glycerol was used in the ratio of 1:2 and 1:1 to cellulose acetate, the polymer was prepared in two different concentrations of 5% and 10% in acetone. It was observed that the lower cellulose acetate concentration allowed the tablet to release all the content in 7 days as can be seen in FIG. 16, compared to the higher coating concentration that allowed up to 50% of the vitamin to release in the same period. The tablet was taken out and checked at each time point for inspection. It was found that the content of nutrients reduced with time and only the coating layer remained after 7 days, as can be seen in FIG. 18.

Referring now to FIG. 20—there is provided a Water Enrichment Capsule 100 which can be easily connected to an ingress end of a straw (preferably used in a drinking bottle) hence enriching water consumed by the end user. The connection between the water enrichment capsule and the straw is done via a universal, funnel shaped, connector 200 allowing a wide range of straw's widths/diameters to be connected to said water enrichment capsule 100.

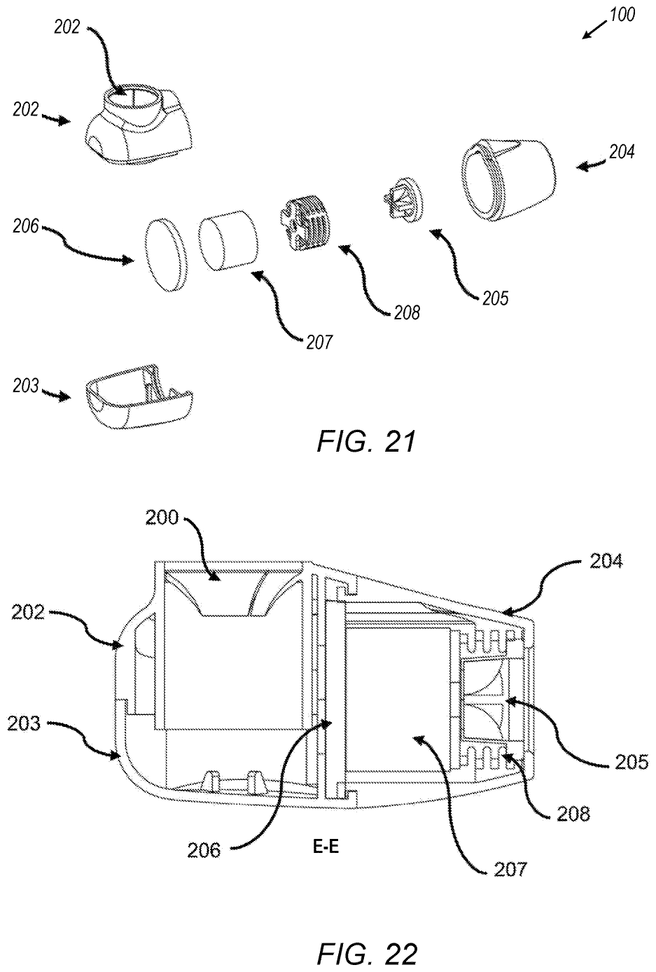

Referring to FIG. 21 and FIG. 22, there is provided an exploded perspective view of the water enrichment capsule 100 comprising at the ingress end an ingress housing 201 formed by a top skin 202 and bottom skin 203 and a shell 204 at the egress end of the water enriching capsule 100. The top skin 202 includes a funnel shaped connector 200 enabling a large range of straws' widths/Diameters to connect to. The ingress housing 201 may comprise a duckbill valve 205 allowing a unidirectional flow of water from the outer reservoir, preferably a drinking bottle, into the water enrichment capsule 100. The water flow through the activated carbon layer 206 aiming to remove small particles. The water further flows through the enrichment unit 207 which enriches the water with nutrition additives as explained above. The ingress housing 201 may also comprise a spring 208 which at the initial stage is pressed by the enrichment unit 207 and gradually expands as the enrichment unit's 207 gradual degrades from usage. Once the enrichment unit 207 is fully exhausted, the spring 208 becomes fully expanded indicating that the water enrichment capsule 100 should be replaced. The elongation of the spring 208 may also physically block the water enrichment capsule 100 from further usage. It is to be noted that the enrichment unit 207 does not have to fully disappear in order to indicate that the water enrichment capsule 100 should be replaced, even a formation change of the enrichment unit 207 may cause sufficient expansion of the spring.

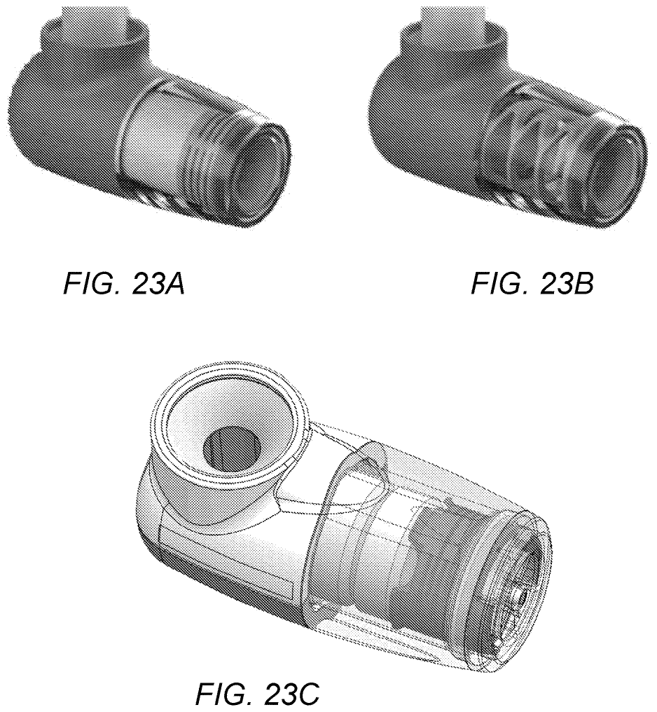

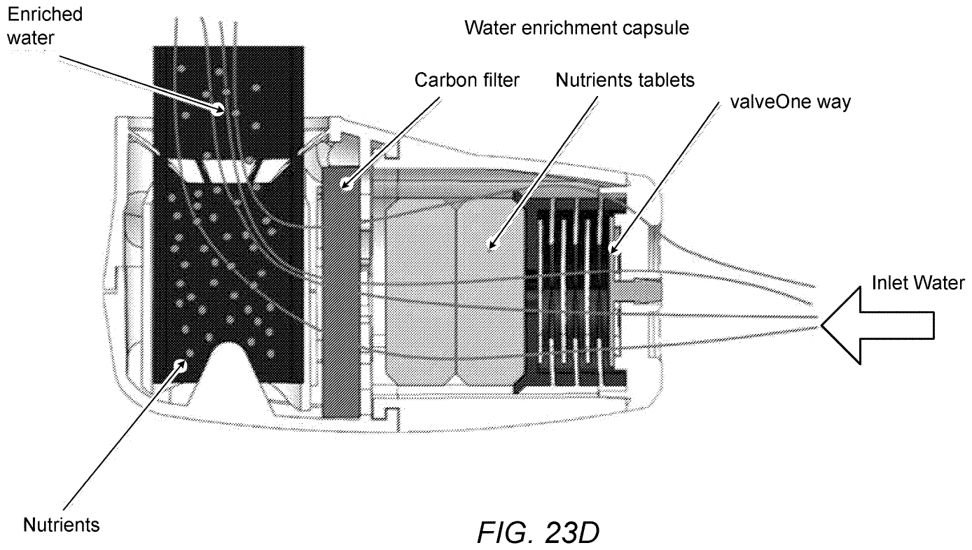

Referring now to FIG. 23A show the water enrichment capsule 100 before usage, as can be appreciated, the spring 208 is in its compressed mode and the enrichment unit 207 exists in its full form whilst FIG. 23B show the enrichment capsule 100 after usage, the spring is fully extended and the enrichment unit 207 fully lost its volume.

### Example 6

### Water Enrichment

### Tablets Details and Compositions:

Tablet were prepared using KORSCH PH 100 Tablet Press using the compositions mentioned in the tables below:

### Tablets Details:

| | |
|---|---|
| Thickness | 6 mm |
| Diameter | 15 mm |
| Weight | 1.2 g |
| Hardness | 150 N |

### Vitamins Tablets—Composition and Preparation

The appropriate amount of vitamin B1, B3, B6, B7, B9, and PVP K30 sieved through #20 sieve and mixed in Y-cone mixer for 10 min, then transferred in into the granulation machine with 100 mL of DDW for 5 min to obtain the granulate. The granulated powder dried in fluid bed drier for 15 min with inlet air temperature of 60° C. The dried granulate milled using oscillated granulator with 0.5 mm sieve.

The appropriate amount of Na-Ascorbate and Avicel PH 101 was mixed with the milled granulate using Y-cone mixer for 10 min. Then the appropriate amount of Mg-stearate was added and mixed for 2 min. The final powder was used to prepare the tablets.

| | | Dose in | |
|---|---|---|---|
| | Recommended | our tablet | Daily single dose in |
| Compound | daily dose | [mg] | commercial tablet |
| Biotin (B7) | 0.05 mg | 1 | 0.03 mg |
| niacinamide (B3) | 15 mg | 100 | 20 mg |
| Pyridoxine HCl (B6) | 1.5 mg | 15 | 0 |
| Folic acid (B9) | 0.2 mg | 3 | 0.5 mg |
| Vitamin B12 | 0.02 mg | 1 | 0.1 mg |
| Na-Vitamin C | 90 mg | 830 | 120 mg |
| MCC (PH101) | Excipient | 225 | — |
| PVP 30K | Excipient | 20 | — |
| Mg Stearate | Excipient | 5 | — |

### Minerals Tablets—Composition and Preparation

The appropriate amount of magnesium sulphate, copper sulphate, manganese chloride, zinc picolinate, Avicel ph101, magnesium stearate, and Aerosil 200 sieved through #20 sieve then the powder mixed in Y-cone mixer for 10 min. The final powder was used to prepare the tablets.

| | Recommended | Dose in our tablet | Daily single dose in |
|---|---|---|---|
| Material | daily dose | (mg) | commercial tablet |
| Mg Sulphate | 300 mg | 955 | 300 mg |
| Zn Picolinate | 1.5 mg | 15 | 1.5 mg |
| Mn chloride | 2 mg | 10 | 2 mg |
| Cu Sulphate | 0.9 mg | 5 | 0.9 mg |
| Aerosil 200 | Excipient | 10 | — |
| MCC (PH101) | Excipient | 200 | — |
| Mg Stearate | Excipient | 5 | — |

### Release Tablets—Composition and Preparation:

The appropriate amount of vitamin B1 and PVP K30 sieved through #20 sieve and mixed in Y-cone mixer for 10 min, then transferred in into the granulation machine with 100 mL of DDW for 5 min to obtain the granulate. The granulated powder dried in fluid bed drier for 15 min with inlet air temperature of 60° C. The dried granulate milled using oscillated granulator with 0.5 mm sieve.

The appropriate amount of magnesium sulphate, zinc picolinate, and Avicel PH 101 was mixed with the milled granulate using Y-cone mixer for 10 min. Then the appropriate amount of Mg-stearate and Aerosol 200 was added and mixed for 2 min. The final powder was used to prepare the tablets. Those tablets were used in the optimization of the coating process, and in the preliminary release experiment to determine the release from the coated tablets.

| Material | Used form | Dose in tablet [mg] |
|---|---|---|
| Vitamin B1 | Thiamin HCl | 90 |
| Magnesium | Mg Sulphate | 800 |
| Zinc | Zinc Picolinate | 100 |
| Avicel PH 101 | Excipient | 200 |
| Aerosil 200 | Excipient | 5 |
| Mg stearate | Excipient | 5 |
| | Sum | 1200 |

### Tablet Press:

Model: KORSCH PH 100 Tablet Press

Machine description: high precision rotary tablet press designed specifically for product development, optimization, and the production of small volume clinical supplies.

### Machine Specifications:

| | |
|---|---|
| Punch Stations | 6 |
| Press Tools | TSM B |
| Maximum Compression | Force 40 kN |
| Press Speed | 15-90 RPM |
| Maximum Fill Depth | 15 mm |
| Upper Punch Insertion Depth | 2 mm |
| Maximum Tablet Thickness | 8 mm |
| Power Supply | 220 VAC, 3-Phase, 60 Hz |
| Net Weight | 350 kg |
| Maximum capacity | 32,400 tablets/hour |

Tablets Coating with Organic Solution:

The tablets were coated in the pan coating using 3-4% (w/v) cellulose acetate acetone solution. The parameters and conditions during the coating process are mentioned below. The tablets were weighed before and after the coating process to calculate the coating weight gain.

Coating polymer: Cellulose acetate 50 kDa from Sigma Aldrich

Plasticizer: Diethyl phthalate from Thermo-Scientific.

Porous inducers: Polyethylene glycol (PEG, Mn=200 kD, Mn=400, and Mn=1500 kDa), Hydroxy Propyl Cellulose (HPC, Mw=14 kDa)

| Process equipment | |
|---|---|
| Nozzle | SCHLICK 930/7-1S 45 Bore diameter 0.5 mm |
| Partition | ~15 cm |
| Pump | GOLANDER YZ 15 peristaltic pump |
| Coating conditions | |
| Tablets load | ~100 tablets (average tablet weight 1-1.2 g) |
| Drying air temp (° C.) | 62-67 |
| Pumping rate (mL/min) | 15 |
| Automizing air (Bar) | 0.5 |
| Pattern Air (bar) | 4 |
| Coating time | |
| Film coating (min) | 17 |
| Post drying (min) | 3 |

### The Coating Details are Given in the Table Below:

| | Polymer solution | | Porous enhancer | | | | |
|---|---|---|---|---|---|---|---|
| Sample | | Concentration | | amount | Ratio to | Pumping | weight |
| code | Amount | in solution | Type | (g) | polymer | rate | gain |
| MAE-7- | 10 | 4% (w/v) | PEG 1500 | 5 | 50% | 15 | 6.4% |
| 44-A | | | | | | mL/min | |
| MAE-7- | 7.5 | 3% (w/v) | PEG 1500 | 3.75 | 50% | 15 | 4.4% |
| 44-B | | | | | | mL/min | |

### Coating Stability:

The coating stability in aqueous condition was determined by placing one coated tablet in 50 ml DDW at 75 rpm shaking. The tablets were checked daily to determine the stability of the coating for one week and to eliminate any leaky tablets with broken or punctured coating. The experiment was run in triplicate.

### Release Machine:

The release was done by placing one or two tablets in the tablets chamber. The chamber sealed properly and connected to the pump using silicon pipe (length=15-20 cm). The tablets chamber placed in water and the release started. The release was monitored by collecting ~50 mL every 20-30 min, and a total daily volume of 1 L was collected.

### Passive Release:

The release from the coated tablets (release tablets) was determined in 50 mL and 500 mL DDW at 75 rpm. The medium was replaced daily and monitored by UV to determine the release of vitamin B1 while the release of the minerals (Mg and Zn) is monitored using Lovibond device. In each release experiment, 5 tablets were used.

### Results:

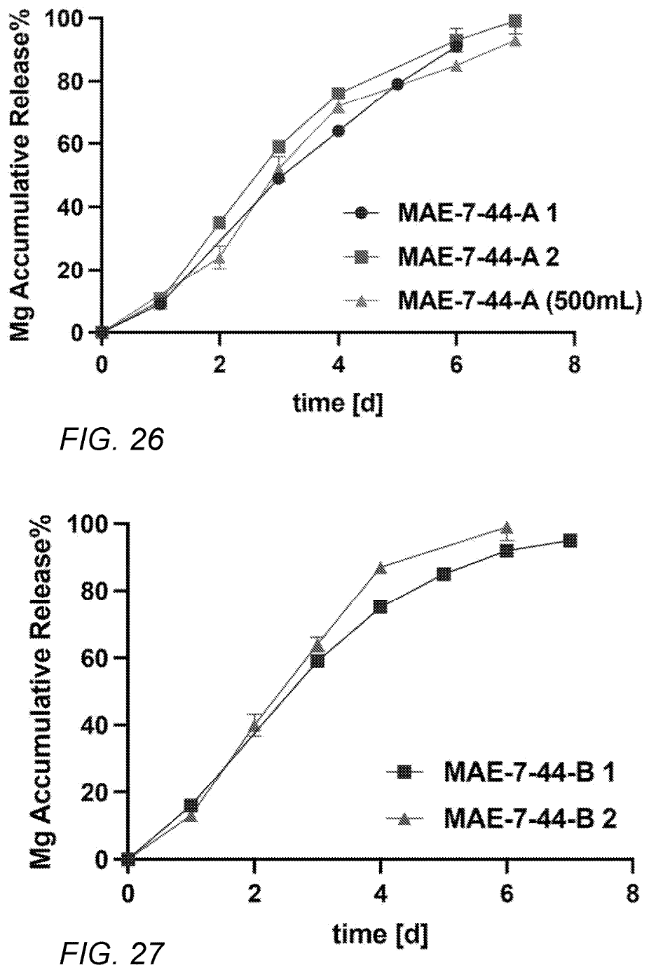

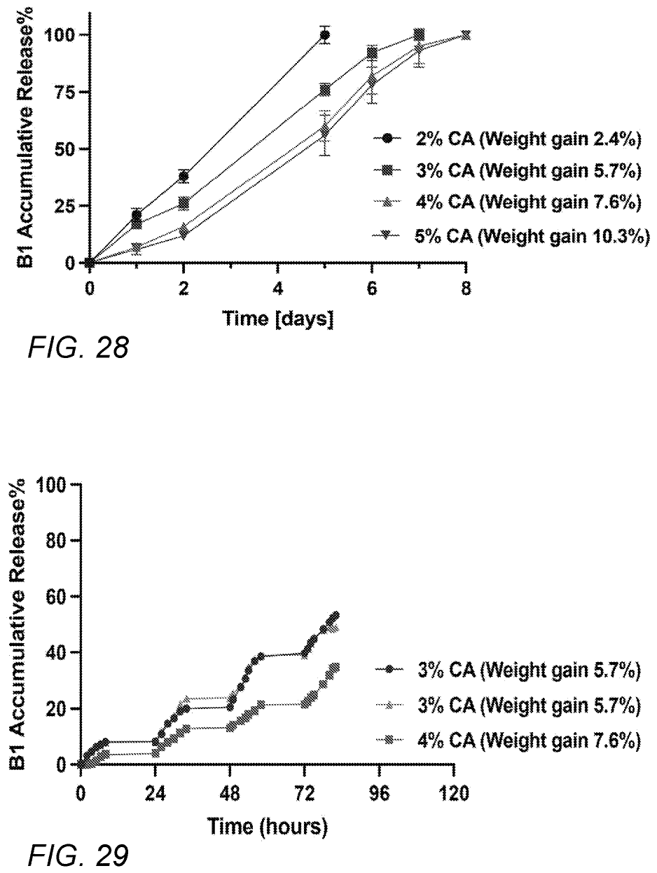

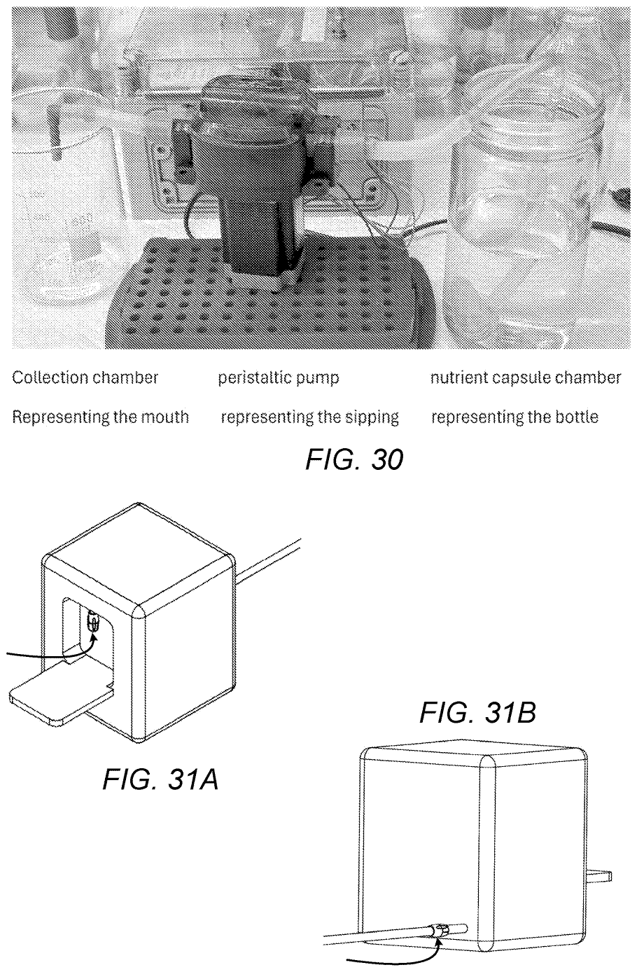

Coating solution composed of cellulose acetate at 3 or 4% w/w acetone solution, PEG 1500 used as porous inducer in the ratio of 50% w/w to the cellulose acetate. The release of vitamin B1 was linear from the coated tablets for a period of 1 week (7 days) and the release experiment was performed in 50 mL volume (repeated twice) and in 500 mL. Average data of the release graph the 4% cellulose acetate solution presented in FIG. 244, and the graph of 3% cellulose acetate solution presented in FIG. 25. The release from the 3% solution was slightly faster than from the 4%. The coating thickness needed to be determined. The release of magnesium is shown in FIG. 26 and Fig.

### Example 7

### Water Enrichment Using Sipping System

Aim: The aim of this work is to determine the release of vitamins and minerals from the tablets coated with different concentrations of cellulose acetate using PEG 1500 as porous inducer. This report focuses on the tablets coating, stability, and release.

### Material:

Active ingredients: Thiamin HCl (Vitamin B1) from Angene, Magnesium sulphate from Sigma Aldrich
Excipients: Magnesium stearate from Thermo Scientific, Aerosil 200 (fumed silica) from Evonik, Avicel PH101 (MCC), and Povidone K30 (polyvinylpyrrolidone) from Sigma Aldrich
Coating polymer: Cellulose acetate 50 kDa from Sigma Aldrich
Plasticizer: Diethyl phthalate from Thermo-Scientific.
Porous inducers: Polyethylene glycol (PEG, Mn=1500 kDa),

### Method:

### Tablets Composition (15 mm Tablets):

| Material | Used form | Dose in tablet [mg] |
|---|---|---|
| Vitamin B1 | Thiamin HCl | 120 |
| Magnesium | Mg Sulphate | 860 |
| Povidone K30 | Excipient | 10 |
| Avicel PH 101 | Excipient | 200 |
| Aerosil 200 | Excipient | 5 |
| Mg stearate | Excipient | 5 |
| | Sum | 1200 |

Tablets Coating with Organic Solution:
The tablets were coated in the pan coating using acetone solution of cellulose acetate. The parameters and conditions during the coating process are mentioned in the below Table. The tablets were weighed before and after the coating process to calculate the coating weight gain.

| Process equipment | |
|---|---|
| Nozzle | SCHLICK 930/7-1S 45 Bore diameter 0.5 mm |
| Partition | ~15 cm |
| Pump | GOLANDER YZ 15 peristaltic pump |
| Coating conditions | |
| Tablets load | ~100 tablets (average tablet weight 1-1.2 g) |
| Drying air temp (° C.) | 62-67 |
| Pumping rate (mL/min) | 15 |
| Automizing air (Bar) | 0.5 |
| Pattern Air (bar) | 4 |
| Coating time | |
| Film coating (min) | 17 |
| Post drying (min) | 3 |

### Coating Stability:

The coating stability in aqueous condition was determined by placing one coated tablet in 50 ml DDW at 75 rpm shaking, the tablets were checked daily to confirm no breaking of the coating for up to one week. The experiment was done in triplicate.

### Passive Release:

The release from the coated tablets was determined in 50 mL DDW at 75 rpm. The medium was replaced daily and monitored by UV to determine the release of vitamin B1. The experiment was done in triplicate.

### Mimicking Release of Nutrients Using a Designed Device:

A device mimicking the human sipping process was developed made from a peristaltic pump that delivers water through a tube that runs from the chamber where the tube end is connected to the nutrient releasing capsule with the tablet to a chamber that collects water samples that are seeped through the tube from the nutrient capsule chamber as shown in FIG. 30. The flow rate of water from the nutrient chamber, mimicking the drinking water bottle, to the collection chamber which mimics the human mouth, is fully controlled by an electronic system. The timing and flow rate can be adjusted for automatic sampling for 1 to 10 days or more. The release was done by placing one tablet in the tablet's chamber. The chamber was sealed with silicon and tested to ensure no leakage. Then it was connected to the pump using silicon pipe (15-20 cm length, inner diameter ~4.5 mm). The tablets chamber placed in water and the release started by collecting ~50 mL water. The release was monitored by collecting ~130-170 mL every 1-2 hours, and a total daily volume of 1 L was collected. The released profile was monitored by measuring the UV absorption of vitamin B1 in the samples.

### Results:

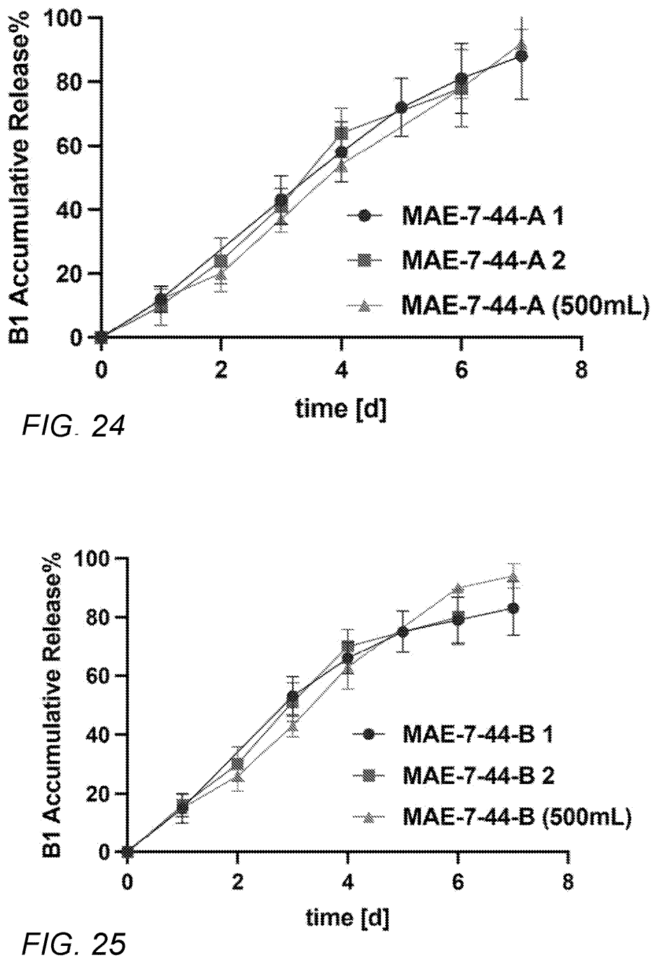

Coating solution composed of cellulose acetate at 2-5% w/w acetone solution, PEG 1500 used as porous inducer in the ratio of 50% w/w to the cellulose acetate, as mentioned in the Table below. All coated tablets were stable for over 7 days in DDW. Average data of the release graph of the different cellulose acetate solution presented in FIG. 24. The tablets coated with CA solution with 3% and 4% concentration were used to determine the release in the machine, and the release graph is presented in FIG. 259.

| | | | Porous enhancer | | | | |
|---|---|---|---|---|---|---|---|
| | Polymer | | | | Ratio to | | |
| Sample | Amount | Concentration | | amount | polymer | Pumping | weight |
| code | (g) | (w/v) | Type | (g) | (w/w) | rate | gain |
| MAE-7- | 5 | 2% | PEG 1500 | 2.5 | 50% | 15 | 2.4% |
| 89-A | | | | | | mL/min | |
| MAE-7- | 7.5 | 3% | PEG 1500 | 3.75 | 50% | 15 | 5.5% |
| 89-B | | | | | | mL/min | |
| MAE-7- | 10 | 4% | PEG 1500 | 5 | 50% | 15 | 7.5% |
| 90-A | | | | | | mL/min | |
| MAE-7- | 15 | 5% | PEG 1500 | 7.5 | 50% | 15 | 10.3% |
| 90-B | | | | | | mL/min | |

### Example 8

a Pod Made from Reusable Polymers or Biodegradable Components

The pod or holder of the tablets is made of polymers that are approved for being in contact with drinking water and can be dismantled into components that can be reassembled into a pod for reuse or melted into plastics for making new pods or needed plastic elements. The pod is made of a biodegradable aliphatic polyester made from lactic acid, glycolic acid, caprolactone or hydroxybutyrate. The coating of the nutrient tablet is also coated with a biodegradable polymer containing a hydrophilic porogen such as glycerol, a sugar, a water-soluble salt or polyethylene glycol. The release of nutrients is controlled by the membrane pore size and thickness. A biodegradable plasticizer such as triethyl citrate or tributyl citrate (TBC) or tributyl citrate acetate. In a typical coating, PLA: TBC: PEG1000 at a w/w ratio of 1:0.05:0.5 dissolved in ethyl acetate and spray coated onto nutrient tablets. The 5% loading tablet coating onto a 1.5-gram tablet, constantly releases the nutrients for 7 days. The pod body is made of high molecular weight PLA containing TBC as plasticizer. At the end of the use of the pod, the used pods are added to a vacuum heating system where the PLA is decomposed into lactide which is collected and re-polymerized into PLA.

### Example 9

### Water Enrichment Capsule Mounted in a Portable Water Supply

A capsule designed to fit the outlet of a water system was prepared by molding a capsule that is hooked to the outlet tube of a water system where the capsule contains a tablet or tablets coated with a controlled release membrane. When passing water through the capsule, an exact nutrient concentration is added to the water. An illustration is shown in FIG. 31.

1.-54. (canceled)

55. A pod for enriching water with one or more nutrients, minerals and/or additives, the pod enclosing an enriched composition of one or more nutrients, minerals and/or additives and is configured to reversibly mount into a water flow path of a drinking apparatus, the pod enclosing a compressed tablet of one or more nutrient, mineral and/or additive, such that a flow of water through the pod dissolves an amount of the compressed tablet at a rate selected to enrich the water with the one or more nutrient, mineral and/or additive, wherein the tablet having a semipermeable coating or a rate controlling membrane selected to release the tablet content over time by diffusion of the nutrients, minerals and/or additives through the coating or membrane.

56. The pod according to claim 55, the pod being a detachable pod configured for reversible installation in a flow path of water flown from a water source to a water output port, the pod having walls defining a chamber or a pocket enclosing an enriched composition of materials; and having one or more ports; at least one port being shaped and structured to receive an end of a water conduit and optionally at least one another port being shaped and structured to receive another end of the water conduit.

57. The pod according to claim 55, having two or more ports, at least one port being shaped and structured to receive an end of an egress end of a water conduit and at least one another port being shaped and structured to receive an ingress end of a water conduit.

58. The pod according to claim 55, wherein the tablet is in a form of a matrix tablet formed of a mixture of the nutrients, minerals and/or additives and inert polymeric materials.

59. A drinking apparatus or a water supply unit configured with a pod according to claim 55, the pod being provided in a water supply line between a water source and a water output port, such that water flowing along the water supply line from the water source to the water output port flows internally to the pod, allowing enrichment of the water exiting the output port with one or more nutrients, minerals and/or additives.

60. The apparatus or unit according to claim 59, being an electrically operated, a mechanically operated, or an electro-mechanically operated water dispensing unit, or a drinking bottle equipped with a drinking rod.

61. The apparatus or unit according to claim 60, wherein the drinking rod is integrally formed with the pod, or wherein the drinking rod is provided with the pod having a port configured to receive the drinking rod.

62. A drinking rod or drinking straw having a water-immersed end equipped with a pod according to claim 55.

63. A water bottle equipped with a drinking rod having a water-immersed end equipped with a pod according to claim 55, the pod being detachably connected to the rod end or is integrally formed therewith.

64. A method for enriching water with nutrients, minerals and/or additives, the method comprising passing a stream of water through a pod according to claim 55 implemented in a water supply unit.

65. The method according to claim 64, wherein the water supply unit is a drinking water bottle mounted with a drinking rod equipped with the pod.

66. The method according to claim 64, for minimizing or preventing diseases and medical conditions associated with deficient consumption of nutrients or materials, the method comprising supplying to a subject suffering or having predisposition from suffering from the medical condition with the water enriched with nutrients, minerals or additives.

67. The method according to claim 64, for enriching a subject's diet with nutrients, minerals or additives, the method comprising dispensing water from a water output port of a water supply unit equipped with the pod, wherein the pod is installed in a water flow path extending from a water reservoir or water tank or water source to the water output port.

68. The method according to claim 64, for enriching a subject's diet with nutrients, minerals or additives, the method comprising mounting or installing the pod in a water flow path extending from a water reservoir or water tank or water source to a water output port of a water supply unit, and dispensing water from the water output port of the water supply unit.

69. The pod according to claim 55 formed of a biodegradable material or a reusable material.

70. A device for determining ability of a pod according to claim 55 to enrich water with nutrients, the device comprising a water line equipped with the pod, the water line having a first end for drawing water from a water reservoir and a second end for outputting water passing through the pod.
